(19) United States
(12) Patent Application Publication
(10) Pub. No.: US 2007/0071481 A1
(43) Pub. Date: Mar. 29, 2007

(54) Image-forming apparatus, process cartridge, and developing cartridge

(75) Inventor: Naoya Kamimura, Nagoya-shi (JP)

Correspondence Address: BANNER & WITCOFF, LTD.;ATTORNEYS FOR CLIENT NOS. 0166889, 006760, 1001 G STREET, N.W., 11TH FLOOR, WASHINGTON, DC, 20001-4597, US

(73) Assignee: Brother Kogyo Kabushiki Kaisha, Nagoya-shi (JP)

(21) Appl. No.: 11/523,632

(22) Filed: Sep. 20, 2006

(30) Foreign Application Priority Data
Sep. 26, 2005 (JP) 2005-277470
Dec. 27, 2005 (JP) 2005-376544

(51) Int. Cl. G03G 15/00; G03G 15/04

(52) U.S. Cl. 399/90; 399/119

(57) ABSTRACT

The pressed area mounted on the developer cartridge case is pressed towards a developer cartridge pressing direction. The developer roller and the photosensitive drum are in contact at a contact position. Power is supplied to the developer cartridge when the power supply protrusion connected electrically to the developer roller rotation drive axis and the power supply part mounted on the outside of the developer cartridge are pushed together in the power supply pressing direction. Here, the power supply pressing direction is semi-orthogonal to the pressing action line that connects the pressing position and the contact position. Furthermore, the power supply protrusion crosses the pressing action line.

### CROSS REFERENCE TO RELATED APPLICATIONS

This application claims priority from Japanese Patent Application Nos. 2005-277470 filed Sep. 26, 2005 and 2005-376544 filed Dec. 27, 2005, the entire contents of which are incorporated herein by reference.

### FIELD

Aspects of the present invention relate to an image-forming apparatus wherein a developing cartridge is configured in a freely attachable/removable manner. Aspects also relate to a process cartridge configured in a freely attachable/removable manner with respect to the body frame of the image-forming apparatus. In addition, aspects relate to a developing cartridge configured in a freely attachable/removable manner.

### BACKGROUND

Japanese Unexamined Patent Application Publication 2005-258344 describes an image-forming apparatus in which a process cartridge is configured in a freely attachable/removable manner with respect to the unit casing (body frame) of the image-forming apparatus. A drum frame including the casing of the process cartridge is configured in a manner allowing the developing cartridge to be installed in a freely attachable/removable manner. Within the drum frame there are contained a photosensitive drum and a scorotron-type charger.

The photosensitive drum includes a grounded drum unit and a photo-conducting layer formed on the surface of the drum unit. The scorotron-type charger is disposed upward from the photosensitive drum and separated by a predetermined gap. The scorotron-type charger is configured so as to charge uniformly the surface of the photosensitive layer of the photosensitive drum (“surface of the photosensitive drum” hereinafter). After the surface of the photosensitive drum is charged uniformly by the scorotron-type charger, an electrostatic latent image is formed on by exposing the surface based on the image information.

The developing cartridge is equipped with a toner housing which houses a toner serving as a developing agent. In the developing cartridge there are also housed a developing roller, a supply roller, and a toner layer thickness-regulating blade.

The developing roller is configured so as to be able to carry the charged toner at its periphery. The developing roller is configured so as to allow the toner in a pattern corresponding to the electrostatic latent image to be adhered to the surface of the photosensitive drum by being brought into contact with the surface of the photosensitive drum whereon the electrostatic latent image is formed. In other words, the developing roller is configured so as to allow the electrostatic latent image to be developed by the toner carried at the periphery of the developing roller.

The supply roller is configured so as to be able to supply the toner to the developing roller. The toner layer thickness-regulating blade is configured so as to be able to regulate the amount of the toner carried on the periphery of the developing roller to which the toner is supplied by a developing agent supply unit.

The image-forming apparatus is also configured so as to allow a predetermined developing bias voltage to be applied between the developing roller and the grounded, photosensitive drum. Specifically, a power supply electrode electrically connected to the output terminal of a high-voltage power supply circuit is provided in the unit casing. The power supply electrode is configured so as to be able to supply power to the developing roller via a bearing member at the rotation drive central axis of the developing roller by pressing on the bearing when the process cartridge in which the developing cartridge is attached is itself attached to the unit casing.

Image-forming by a conventional image-forming device provided with such a structure is carried out as follows.

First, the surface of the photosensitive drum is charged uniformly by the scorotron-type charger. Next, the electrostatic latent image is formed by exposing the surface of the uniformly charged, photosensitive drum based on the image information.

Then, the surface of the photosensitive drum whereon the electrostatic latent image is formed confronts the periphery of the developing roller whereon the charged toner is carried. The toner in a pattern corresponding to the electrostatic latent image is thereby adhered to the surface of the photosensitive drum. In other words, an image produced by the toner (developing agent image) is formed on the surface of the photosensitive drum. An image is formed on the surface of a recording medium by transferring the developing agent image to the recording medium.

### SUMMARY

According to aspects of the invention, an image formation device may include a developer cartridge having a developer carrier configured to carry a developer, a developer cartridge case configured to house the developer carrier, and a conductive member mounted on the developer cartridge case and electrically connected to the developer carrier. The device can further include a developer cartridge mounting frame having an image carrier configured to form an image on a recording medium using the developer carried on the developer carrier by contacting the developer carrier at a designated contact position, wherein the developer cartridge is configured to be installed in and removed from the developer cartridge mounting frame. In addition, the device can include an urging member configured to urge in a pressing direction a portion of the developer cartridge case at a designated pressing position, and wherein in response to the urging member urging the portion of the developer cartridge case, the developer carrier is pressed against the image formation carrier at the contact position. The device may also include a power supply member configured to allow the conductive member to receive power when contacting the power supply member in a direction perpendicular to a line that connects the contacting position and the pressing position.

According to another aspect of the invention, a process cartridge may be configured to be installed in and removed from a frame of an image forming device. The process cartridge can include a developer cartridge that includes a developer carrier configured to carry a developer, a developer cartridge case configured to house the developer carrier and the developer, and a conductive member provided on the developer cartridge case, the conductive member being electrically connected to the developer carrier, the developer cartridge case including a portion urged in a pressing direction by an urging element at a designated pressing position. Also, the process cartridge may include a process cartridge frame that holds an image carrier to which the developer is carried by contacting the developer carrier at a designated contact position, the developer cartridge being configured to be installed in and removed from the process cartridge frame. The conductive member can be configured to be pressed by a power supply member in a direction perpendicular to a line that connects the pressing position and the contacting position.

According to still another aspect, a developer cartridge may be configured for use in an image forming device including an image carrier configured to be supported in a developer cartridge mounting frame, which is configured to be supported inside the image forming device, the developer cartridge being configured to be installed in and removed from the developer cartridge mounting frame. The developer cartridge can include a developer carrier configured to carry the developer, a developer cartridge case configured to house the developer carrier, and a conductive member mounted on the developer cartridge case and electrically connected to the developer carrier. The developer cartridge case may be configured to allow the developer carrier to be pressed, at a designated pressing position, against the image carrier, and the conductive member may be configured to be supplied with power while being pressed by a power supply member in a direction perpendicular to a line that connects a contacting position where the developer carrier and the image carrier contact each other, and the designated pressing position.

### BRIEF DESCRIPTION OF THE DRAWINGS

FIG. 1 is a cross-section of a laser printer constituting an image formation device according to aspects of the invention.

FIG. 2 is a plan view of a process cartridge of the laser printer shown in FIG. 1.

FIGS. 3A and 3B are left and right a side views of the developer cartridge of the process cartridge shown in FIG. 2, respectively

FIG. 4 is a plan view of the developer cartridge shown in FIG. 2 and FIGS. 3A and 3B.

FIG. 5 is a plan view of a photosensitive unit of the process cartridge shown in FIG. 2.

FIG. 6 is a side view of the photosensitive unit shown in FIG. 5.

FIG. 7 is a magnified perspective view of a pressing mechanism of the photosensitive unit shown in FIG. 6.

FIG. 8 is a schematic side view illustrating mounting and removal of the process cartridge from a unit frame of the image formation apparatus shown in FIG. 1.

FIG. 9 is a magnified view of the process cartridge shown in FIG. 8.

FIG. 10 is a schematic side view illustrating an intermediate stage of the mounting of the process cartridge onto the unit frame shown in FIG. 1.

FIG. 11 is a schematic side view illustrating another possible formation of the process cartridge in the aspects shown in FIG. 9.

FIG. 12 is a perspective view of the color laser printer according to aspects of the present invention.

FIG. 13 is a front view of a developer cartridge of the color laser printer shown in FIG. 12.

FIG. 14 is a perspective rear view of the developer cartridge shown in FIG. 13.

FIG. 15 is a perspective front view of the developer cartridge shown in FIG. 14.

FIG. 16 is a perspective front view of the developer cartridge shown in FIG. 14.

FIG. 17 is a perspective birds-eye view of a process unit of the color laser printer shown in FIG. 12.

FIG. 18 is a magnified perspective view of the elements of a photosensitive unit of the process unit shown in FIG. 17.

FIG. 19 is a perspective oblique view of the photosensitive unit shown in FIG. 17.

FIG. 20 is a perspective oblique view of the photosensitive unit shown in FIG. 17 seen from the opposite side from FIG. 19.

FIGS. 21A and 21B are side views of the developer cartridge shown in FIG. 13 in a non-pressed state (retired state), and a pressed state, respectively.

FIG. 22A and 22B are magnified side cross-sections of the vicinity of the pressing action mechanism shown in FIGS. 21A and 21B in the non-pressed state, and the pressed state, respectively.

FIG. 23(A) is a side view of the opposite side of the developer cartridge in the pressed state shown in FIG. 21B and FIG. 23(B) is a schematic view illustrating the force acting on the developer cartridge in the pressed state shown in FIG. 23A.

FIG. 24 is a magnified side view of the vicinity of the conductive part shown in FIGS. 23A and 23B.

FIG. 25 is a magnified perspective view of the vicinity of the process unit shown in FIG. 12.

FIG. 26 is a magnified perspective view of the vicinity of a slide guide frame and a linear cam mechanism of the color laser printer shown in FIG. 12.

FIG. 27 is a perspective view of one part of the cylindrical cam parts shown in FIG. 26.

FIGS. 28A and 28B are magnified perspective views of the auxiliary cam part shown in FIG. 27 in which the auxiliary cam part is fallen (fallen state), and the auxiliary cam part is standing (standing state), respectively.

FIGS. 29A and 29B are magnified perspective views of the cylindrical cam part and auxiliary cam part shown in FIG. 27) where the cylindrical cam part is in the foremost position and the cylindrical cam part is in the rearmost position, respectively.

FIG. 30 is a side cross-section of the cylindrical cam part and auxiliary cam part with the cylindrical cam part shown in FIG. 29B.

FIG. 31 is a side cross-section of the cylindrical cam part and auxiliary cam part with the cylindrical cam part shown in FIGS. 29A and 29B in an intermediary position.

FIG. 32 is a side cross-section of the cylindrical cam part and auxiliary cam part with the cylindrical cam part shown in FIG. 29A.

FIG. 33 is a magnified side view of the developer cartridge and linear cam mechanism with the cylindrical cam part of the process unit shown in FIG. 25 moved to the rearmost position.

FIG. 34 is a magnified side view of the developer cartridge and linear cam mechanism with the cylindrical cam part of the process unit shown in FIG. 25 in an intermediate position.

FIG. 35 is a magnified side view of the developer cartridge and linear cam mechanism with the cylindrical cam part of the process unit shown in FIG. 25 moved to the foremost position.

FIG. 36 is a view from the underside of a delivery cartridge mounted on the unit frame shown in the color laser printer of FIG. 12, and a rotational driving force delivery mechanism for delivering rotational driving force to this developer cartridge.

FIG. 37 is a view from the underside of a delivery cartridge mounted on the unit frame shown in the color laser printer of FIG. 12, and a rotational driving force delivery mechanism for delivering rotational driving force to this developer cartridge.

### DETAILED DESCRIPTION

Below, aspects of the present invention are explained with reference to the drawings.

Overall configuration of a laser printer

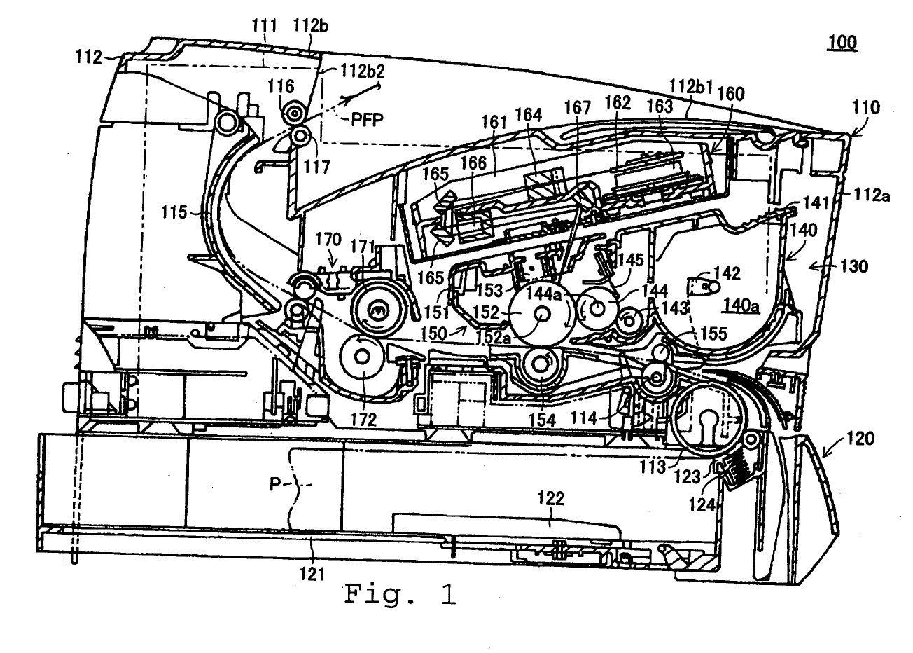

FIG. 1 is a side cross-sectional view of a monochrome laser printer 100 that is an image forming device according to aspects of the present invention.

A monochrome laser printer 100 includes a main unit 110 and a feeder unit 120. The main unit 110 is configured to form an image on a paper P while conveying the paper (recording medium) P supplied by the feeder unit 120 along a paper feed path PFP (illustrated by the double-chain line in the drawing).

In the following explanation, the direction in which the paper P is conveyed along the paper feed path PFP in FIG. 1 is called the “paper feed direction.”That is, the paper feed direction at a certain position along the paper feed path PFP is parallel to the direction tangent to the paper feed path PFP at that position and is the direction along the direction of movement of the paper P at that position.

In addition, the direction that orthogonally intersects the paper feed path PFP, that is, the direction that orthogonally intersects the paper surface in FIG. 1 is called the “width direction.” This “width direction” is the direction that matches the direction of the width of the paper. In addition, this “width direction” is a direction that orthogonally intersects the direction of the thickness of the paper P, the direction of the height of the monochrome laser printer 100, and the paper feed direction.

Furthermore, the right side of the figure of the monochrome laser printer 100 is called the “front side” of the monochrome laser printer 100 and the left side of the figure of the monochrome laser printer 100 is called the “rear side” of the monochrome laser printer 100.

The feeder unit 120 is arranged in the bottom of the main unit 110. The feeder unit 120 is configured to hold the sheet paper P in a stack for feeding to the interior of the main unit 110. In some aspects, the monochrome laser printer 100 and the feeder unit 120 are configured to handle letter size (215.9 mm×279.4 mm) and A4 size (210 mm×297 mm) paper P. The feeder unit 120 is configured to be mounted from the above-mentioned front side in the direction of the above-mentioned rear side of the bottom of the main unit 110.

A process cartridge 130 is accommodated on top of the feeder unit 120 inside the main unit 110. The process cartridge 130 is arranged in the above-mentioned front side and in the approximate center of the above-mentioned width direction inside the main unit 110. In addition, the process cartridge 130 is configured to form an image on the paper P using a toner (a developing agent). The process cartridge 130 is configured to be freely insertable in and removable from the main unit 110.

The process cartridge 130 includes a developer cartridge 140 and a photosensitive unit 150. The developer cartridge 140 is configured to be freely insertable in and removable from the photosensitive unit 150.

In addition, a scanner unit 160 and a fixing unit 170 are provided inside the main unit 110.

The scanner unit 160 is configured to generate a laser beam to accompany the formation of a toner image in the process cartridge 130 and can irradiate the beam toward the process cartridge 130.

The fixing unit 170 is configured to fix a toner image formed on a paper P by the process cartridge 130 onto the paper P.

Specific configurations of a body portion 110, a process cartridge 130, a developing cartridge 140, a photosensitive unit 150, a scanner unit 160, and a fixing unit 170 are described below.

Body Portion

The body portion 110 includes a body frame 111 supporting the process cartridge 130. The body frame 111 is made of a synthetic resin.

Body Cover

The body portion 110 includes a body cover 112. The body cover 112 is formed to cover the outside of the body frame 111. This body cover 112 is made of a synthetic resin plate material.

At the front side of the body cover 112, a front cover 112a is set. This front cover 112a is capable of being opened and closed. That is, when the front cover 112a is opened, an opening is formed for attaching and detaching the process cartridge 130 at the front side of the body cover 112.

A concavity is formed at the back side (the left side in the figure) in the top cover 112b including the upper surface of the body cover 112. This concavity is formed in such a shape that it becomes deeper in the direction from the front side (the right side in the figure) to the back side. Then, a sheet delivery tray 112b1 is formed by the concavity.

That is, the sheet delivery tray 112b1 includes a slope formed diagonally extending downward from the front side (the right side in the figure) of the top cover 112b to the back side (the left side in the figure). The sheet delivery tray 112b1 is configured such that sheets P on which images are formed can be stacked in a multilayer state.

Also, at the upper side of the lower end portion of the sheet delivery tray 112b1 in the body cover 112, a sheet delivery outlet 112b2 with an opening portion is formed. The sheet delivery tray 112b1 is configured to be capable of receiving sheets P that have been delivered with images from the sheet delivery outlet 112b2.

Sheet Conveyor Mechanism in the Body Portion

A sheet supply roller 113 is installed at the bottom at the front side of the body portion 110. The sheet supply roller 113 is made of a rubber roller. This sheet supply roller 113 is capable of feeding the topmost sheet in the paper conveyor direction among the sheets P that have been stacked up in a multilayer state in the feeder unit 120.

A resist roller 114 is installed in the process cartridge 130 at the downstream side of the paper feed passage PFP from the paper feed roller 113. The resist roller 114 is arranged at a position facing the resist facing roller 155 equipped at the bottom of the process cartridge 130 as will be described later. The resist roller 114 working in coordination with the resist facing roller 155 corrects the slope at the tip of the sheet P as well as adjusts the passage timing of the tip of the sheet P.

The sheet supply roller 113 and resist roller 14 are arranged to be rotated via a rotary driving force transmission mechanism which is not shown.

Also, a paper guide 115 is installed to guide conveyance of the sheets P along the paper feed passage PFP inside of the body portion 110.

A sheet delivery roller 116 and a sheet delivery sub-roller 117 are arranged such that the front side is exposed to the outside from the sheet delivery output 112b2 in the top cover 112b. Also, the sheet delivery roller 116 and the sheet delivery sub-roller 117 are arranged such that the back side is mounted in the inside of the top cover 112b.

The sheet delivery roller 116 is configured to rotate counter-clockwise due to the rotation drive force transmission mechanism of which is not shown in the figure. The sheet delivery sub-roller 117 is arranged at the downstream side of the sheet delivery roller 116. The sheet delivery sub-roller 117 is supported such that it can be freely rotated by the top cover 112b.

Feeder Unit

A feeder unit 120 includes a feeder case 121, a sheet pressing plate 122, a separation pad 123, and a separation pad urging spring 124.

The feeder case 121 is a member that includes a casing for the feeder unit 120. The feeder case 121 is made of the same synthetic resin plate material as the body cover 112. This feeder unit 120 is configured such that sheets P can be stored in a multilayer state.

A sheet pressing plate 122 is arranged inside of the feeder case 121. This sheet pressing plate 122 is supported such that it can be slid around the edge of the back side.

The separation pad 123 is installed to face the sheet supply roller 113. A friction portion made of a material in which the coefficient of friction with the sheet P is higher than the coefficient of friction among the sheets P is formed on the surface facing the sheet supply roller 113 in this separation pad 123. This friction portion is made of felt and the like. This separation pad 123 is urged towards the upper sheet supply roller 113 due to the separation pad urging spring 124.

Outlined Constitution of a Developing Cartridge

A developing cartridge 140 includes a developing cartridge case 141, an agitator 142, a supply roller 143, a developing roller 144, and a toner layer thickness regulating blade 145.

The developing cartridge case 141 includes a casing for the developing cartridge 140 is made of a synthetic resin plate material. A toner storage chamber 140a is formed at the front side of the developing cartridge case 141. This toner storage chamber 140a is a space for storing a non-magnetic one component toner as a developer.

A blade-shaped agitator 142 is arranged inside of the toner storage chamber 140a. The agitator 142 is supported such that it is rotatable by the developing cartridge case 141. The agitator 142 is capable of agitating the toner stored in the toner storage chamber 140a due to its rotary action. Also, this agitator 142 can feed the toner in small portions towards the supply roller 143 due to its rotary action.

The supply roller 143 is arranged inside of the developing cartridge case 141 at the back side of the toner storage chamber 140a. The supply roller 143 is configured by forming a sponge layer on the outer surface of the metallic rotary shaft. The supply roller 143 is supported by the developing cartridge case 141 such that it can be rotated. Also, the supply roller 143 is rotated in the direction shown by the arrow in the figure (in a counter-clockwise direction) via a rotary drive-force transmission mechanism that is not shown in the figure while forming images.

A developing roller 144 is arranged at the back side of the supply roller 143 inside of the developing cartridge case 141. The developing roller 144 is arranged in parallel to the supply roller 143. When the supply roller 143 is pressed by the developing roller 144, an inter-axial distance is set between the developing roller 144 and the supply roller 143 such that the supply roller 143 is elastically compressed.

The developing roller 144 includes a developing roller rotary drive shaft 144a that is a metallic rotary shaft, and a semi-conductive rubber layer formed on the outer surface of the developing roller rotary drive shaft 144a. The semiconductive rubber layer is formed by uniformly dispersing carbon black into a synthetic rubber.

The developing roller 144 is supported by the developing cartridge case 141 such that it can be rotated. The developing roller 144 is rotated in the direction shown by the arrow in the figure (in a counter-clockwise direction: same direction as the supply roller 143) via the rotary drive force transmission mechanism that is not shown in the figure while forming images. In addition, a charged toner is carried by the rotary drive on the surface of the developing roller 144.

The toner layer thickness regulating blade 145 is configured such that the amount of the toner to be supported on the surface of the developing roller 144 can be adjusted. That is, when the toner layer thickness regulating blade 145 slides against the surface of the developing roller 144, the thickness and density of the thin toner layer carried on the surface can be adjusted.

Outlined Constitution of a Photosensitive Unit

A photosensitive unit 150 includes a photosensitive unit frame 151, a photosensitive drum 152, a charger 153, a transfer roller 154, and a resist facing roller 155.

The photosensitive unit frame 151 is a member including a casing for the photosensitive unit 150, and is formed of a synthetic resin plate material. This photosensitive unit frame 151 is configured to be freely attachable to and detachable from the developing cartridge 140.

The photosensitive drum 152 is installed inside of the photosensitive unit frame 151. The photosensitive drum 152 includes a metallic cylindrical member and a photosensitive layer made of a photoconductive material installed on the outer surface of the cylindrical member. The drum shaft 152a is a rotary shaft of the photosensitive drum 152 that is supported by the photosensitive unit frame 151 in a rotatable manner. Also, this drum shaft 152a and the cylindrical member are electrically connected. This drum shaft 152a is also grounded.

The photosensitive drum 152 is arranged parallel to the developing roller 144 in the state when the developing cartridge 140 is installed in the photosensitive unit 150. An inter-axial distance is set between the photosensitive drum 152 and the developing roller 144 such that the surface of the photosensitive drum 152 and the surface of the developing roller 144 are in contact with each other via a thin toner layer carried on the surface of the developing roller 144.

A process cartridge 130 is configured such that a toner image is formed on the surface of the photosensitive drum 152 when the electrostatic latent images formed on the surface of the photosensitive drum 152 are developed by the toner carried on the surface of the developing roller 144.

A charger 153 is arranged in the upper portion of the photosensitive drum 152. The charger 153 is supported by the photosensitive unit frame 151. This charger 153 is made of a known scorotron type charger such that the surface of the photosensitive drum 152 is uniformly charged.

The transfer roller 154 is disposed at the lower side of the photosensitive drum 152 inside of the photosensitive unit frame 151. The transfer roller 154 is disposed in parallel to the photosensitive drum 152 such that it faces the surface of the photosensitive drum 152 having the paper feed passage PFP in between.

The transfer roller 154 is supported in a rotatable manner by the photosensitive unit frame 151. The transfer roller 154 is made by forming a semi-conductive rubber layer on the outer surface of the metallic rotary shaft. A high voltage side output terminal (not shown) is connected to the rotary shaft. That is, a specified transfer voltage is applied between the transfer roller 154 and the photosensitive drum 152 at the transfer position where the transfer roller 154 and the photosensitive drum 152 face each other.

That is, the transfer roller 154 is configured such that it is rotated in the direction shown by the arrow in the figure (in a counter-clockwise direction) synchronous to the rotation in the direction shown by the arrow in the photosensitive drum 152 (in a clockwise direction) while forming images. Also, while the transfer roller 154 is rotated as described above and the transfer voltage is applied in the gap with the photosensitive drum 152, the toner is carried in such a way that images are orientated on the surface of the photosensitive drum 152 and transferred to a sheet P at the transfer position.

A resist facing roller 155 is provided upstream in the paper feed direction from the transfer position outside the bottom of the photosensitive unit frame 151. This resist roller 114 is supported in a freely rotatable manner by the photosensitive unit frame 151.

The resist facing roller 155 is arranged in parallel to the resist roller 114. Also, the resist facing roller 155 is arranged to face the resist roller 114. When the resist facing roller 155 is in contact with the resist roller 114, it is rotated in accordance with the resist roller 114.

Scanner Unit

A scanner unit 160 is arranged in the lower part of the sheet delivery tray 112b1. This scanner unit 160 is supported in the upper part of the process cartridge 130 via the body frame 111. The scanner unit 160 includes a scanner frame 161, a polygon mirror 162, a polygon motor 163, an f-θ lens, a folded mirror 165, a cylindrical lens 166, and an illumination mirror 167.

The scanner frame 161 supports the polygon mirror 162, polygon motor 163, f-θ lens 164, folded mirror, cylindrical lens 166 and illumination mirror 167. The scanner frame 161 is made of a synthetic resin plate material.

The polygon mirror 162 is supported by the rotary drive shaft of the polygon motor 163 fixed in the scanner frame 161. This polygon mirror 162 is configured such that while rotating a specific number of rotations by the polygon motor 163, it reflects the laser beam that is generated in the laser emission unit based on the image data in order to scan in the lateral direction.

The f-θ lens 164 is a lens for correcting the scanning gap of the laser beam reflected from the polygon mirror 162, and is configured such that it has a longitudinal direction along the rotary direction of the polygon mirror 162.

The cylindrical lens 166 is a surface inclination correction lens and is arranged in the moving direction of the laser beam reflected from the folded mirror 165 via the f-θ lens 164. The illumination mirror 167 is arranged such that the laser beam passing the cylindrical lens 166 is irradiated facing the surface of the photosensitive drum 152.

Fixing Unit

A fixing unit 170 is arranged at the downstream side in the paper feeding direction from the transfer position. The fixing unit 170 includes a heat roller 171 and a pressure roller 172.

The heat roller 171 contains a heater within the metallic thin wall cylinder that has been surface treated for releasing mold. The heat roller 171 is arranged in parallel to the lateral direction.

The pressure roller 172 is a silicone rubber roller and is arranged in parallel to the heat roller 171. The pressure roller 172 is pressed against the heat roller 171 using a spring.

This fixing unit 170 is configured such that while a sheet P is inserted between the heat roller 171 and the pressure roller 172 which rotate in the directions shown by the arrows in the figure, toner images adhering on the surface of the sheet P are fixed on the surface and the sheet P is fed in the paper feed direction.

Detailed Configuration of the Process Cartridge

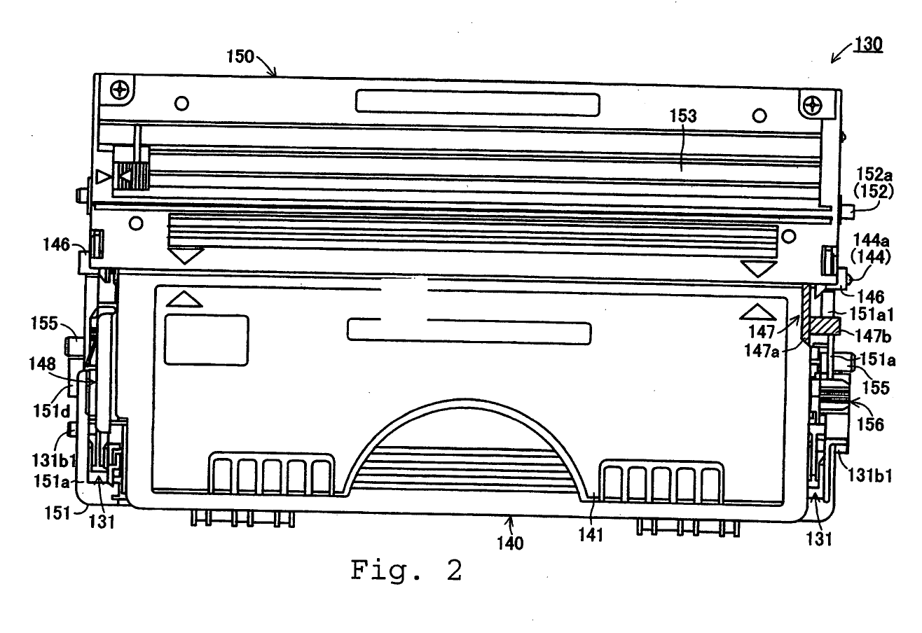

FIG. 2 is a plane view of the process cartridge 130 shown in FIG. 1. With reference to FIG. 2, the process cartridge 130 is contained in the space wherein the developing cartridge 140 is enclosed by a pair of side wall portions 151a in the photosensitive unit frame 151.

This process cartridge 130 contains a pair of urging mechanisms 131. The urging mechanisms 131 are installed between the outer side of the developing cartridge case 141 and the internal side of the pair of the side wall portions 151a. The urging mechanism 131 is provided such that the surface of the developing roller 144 and the surface of the photosensitive drum 152 are in contact with each other in an urged state by urging the developing cartridge case 141 against the photosensitive drum 152. In this aspect, the urging mechanisms 131 are provided inside of the pair of side wall portions 151a. The urging mechanism 131 will be described in detail later.

Detailed Configuration of the Developing Cartridge

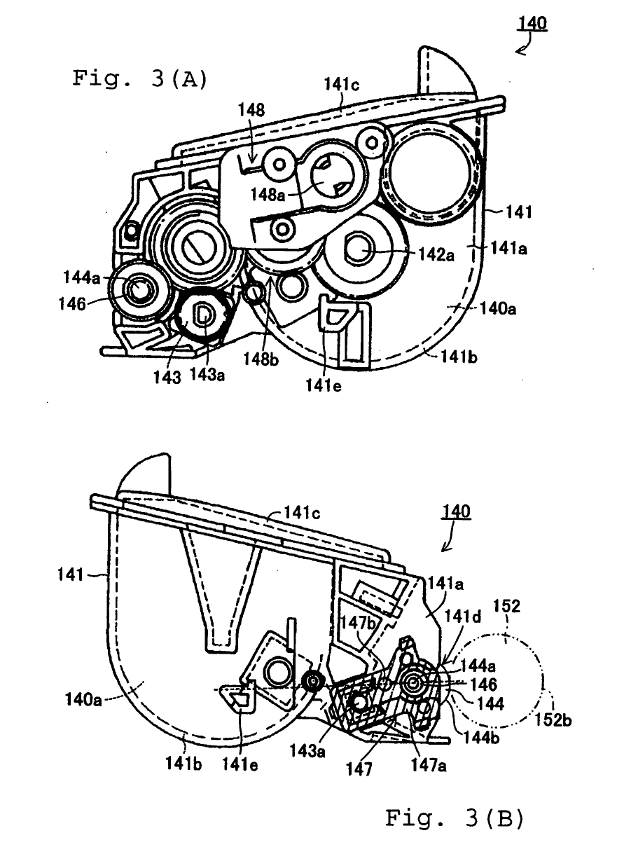

FIGS. 3A and 3B are side views of the developing cartridge 140 shown in FIG. 2. FIG. 3A is a side view when viewed from the same direction as in FIG. 1, namely a left side view. FIG. 3B is a right side view.

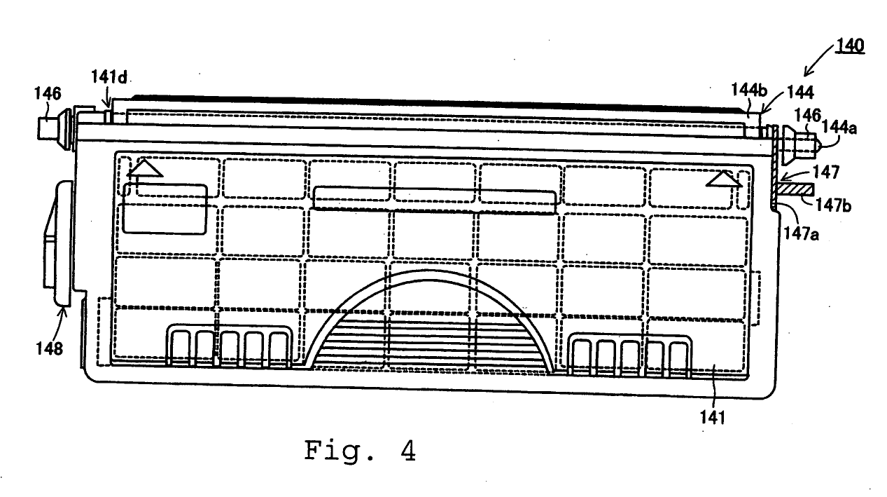

FIG. 4 is a plane view of the developing cartridge 140 shown in FIG. 2 and FIGS. 3A and 3B. That is, FIG. 4 is the developing cartridge 140 when it is detached from the photosensitive unit 150 (photosensitive unit frame 151) in the process cartridge 130 shown in FIG. 2.

With reference to FIGS. 3A and 3B, the developing cartridge case 141 includes a pair of side plates 141a, a bottom plate 141b, and a ceiling plate 141c. A toner storage chamber 140a is formed by the space enclosed by the pair of side plates 141a, the bottom plate 141b and the ceiling plate 141c.

A developing opening portion 141d is formed at the edge, farthest away from the toner storage chamber 140a (at the edge of the downstream side in the paper feed direction) in the developing cartridge case 141. The developing opening portion 141d is formed such that a portion of the toner carrying surface 144b, which is the surface of the developing roller 144, is exposed. That is, with reference to FIG. 3B, the developing cartridge case 141 is provided such that the toner carrying surface 144b of the developing roller 144 is exposed to the image carrying surface 152b of the photosensitive drum 152 via the developing opening portion 144d.

A projecting portion 141e of the developer cartridge case 141 protrudes to away from the pair of the side plates 141a. The projecting portion 141e is configured to be pressed by the urging mechanism when it is in contact with the urging mechanism 131 (See FIG. 2).

With reference to FIGS. 3A and 3B, an almost cylindrical alignment collar (bearing) 146 is installed at and projects from both ends of the developing roller driving shaft 144a. The alignment collar 146 is formed of a material with a small coefficient of friction such as polyacetal resin, etc. The outer surface of the alignment collar 146 is formed to provide a smooth surface in order to achieve smooth sliding on the outer surface that is in contact with other members.

The alignment collar 146 is configured such that it can rotate relative to the developing roller driving shaft 144a. That is, the alignment collar 146 can function as a bearing by sliding the outer surface at both edges of the developing roller driving shaft 144a against the internal surface of the alignment collar 146.

With reference to FIG. 2, the pair of alignment collars 146 is configured such that the developing cartridge 140 and the photosensitive unit 150 are aligned by coupling with the pair of side wall portions 151a of the photosensitive unit frame 151. That is, when the pair of alignment collars 146 is coupled with the pair of side wall portions 151a, the dimensional relationships between the developing roller driving shaft 144a and the drum shaft 152a are set in a specified state so that the dimensional relationships between the surface of the developing roller 144 and the surface of the photosensitive drum 152 are set in a specified state.

With reference to FIG. 3B, a conductive member 147 is installed on the outside of one side plate 141a (right side). The conductive member 147 includes a flat plate base plate 147a and a columnar power supply protrusion 147b. This conductive member 147 is integrally formed of a conductive synthetic resin.

The base plate 147a is attached to the outside of the other side plate 141a (right side). Two through-holes are formed in the base plate 147a. The supply roller driving shaft 143a is inserted into one of the through-holes. The developing roller driving shaft 144a is inserted through the other through-holes. Additionally, the supply roller driving shaft 143a, the developing roller driving shaft 144a, and the base plate 147a are electrically connected by being in contact with each other. That is, the suppler roller 143 and the developing roller 144 are electrically connected via the conductive member 147.

The power supply protrusion 147b is built outwardly from the base plate 147a. With reference to FIG. 2, the power supply protrusion 147b is configured such that when it protrudes from one of the side wall portions 151 a in the photosensitive unit frame 151 in such a state that the developing cartridge 140 is installed in the photosensitive unit 150 (photosensitive unit frame 151), power is supplied from the specific power supply member installed outside of the process cartridge 130.

Again with reference to FIGS. 3A and 3B, a driving force input unit 148 is installed on the side plate 141a at an opposite side (left side) relative to the side where the conductive member 147 is installed. The driving force input unit 148 includes a coupling unit 148a and a gear mechanism 148b.

When the coupling unit 148a is coupled with the driving rotor equipped at the side of the body frame 111 (See FIG. 1), it can receive the driving force from the driving rotor. The gear mechanism 148b includes multiple gears that are configured and arranged such that the driving force received by the coupling unit 148a can be transmitted to an agitator driving shaft 142a, a supply roller driving shaft 143a, and the developing roller driving shaft 144a.

Detailed Configuration of the Photosensitive Unit

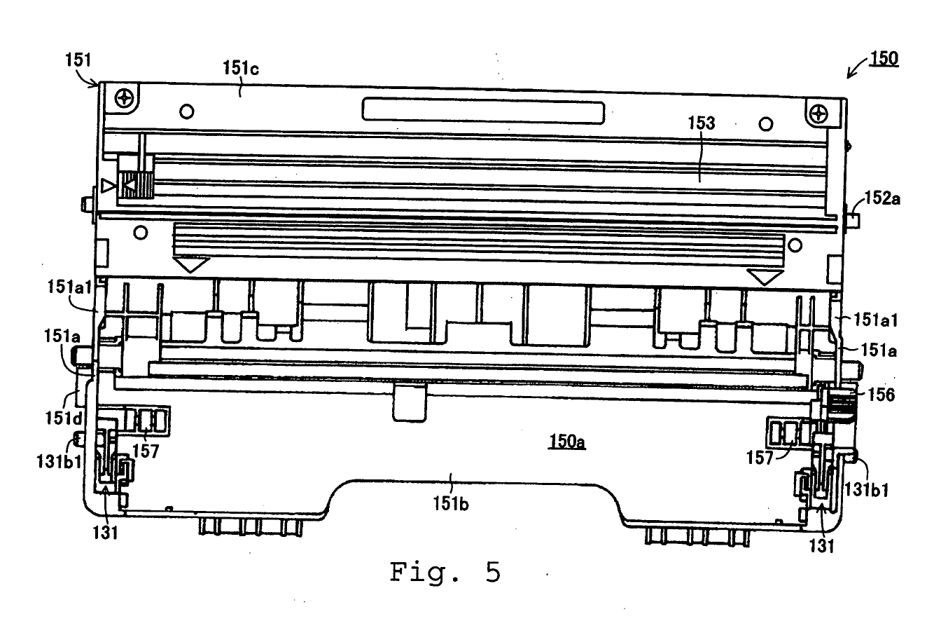

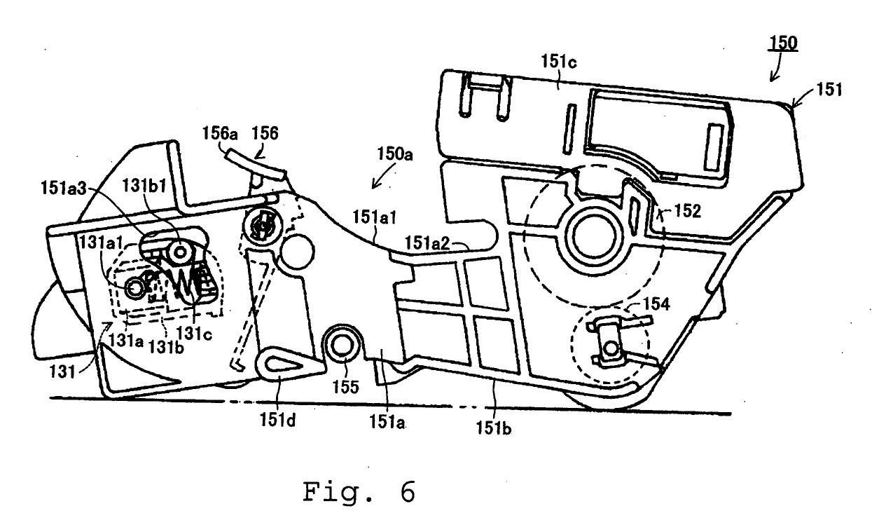

FIG. 5 is a plane view of the photosensitive unit 150 shown in FIG. 2. That is, FIG. 5 is a diagram showing the photosensitive unit 150 in a state that the developing cartridge 140 is detached from the process cartridge 130. Also, FIG. 6 is a side view of the photosensitive unit 150 shown in FIG. 5. FIG. 5 is a side view corresponding to FIG. 3B (right side view).

With reference to FIG. 5 and FIG. 6, the photosensitive unit frame 151 includes a pair of side wall portions 151a, a bottom wall unit 151b, and an upper wall unit 151c.

The bottom wall unit 151b and the upper wall unit 151c are arranged such that they are bridged between the pair of side wall units 151a. In the space enclosed by the pair of side wall units 151a and the bottom wall unit 151b, a developing cartridge storage unit 150a is formed by the portion at the front of the upper wall unit 151c (upstream side in the paper feed direction; lower side in FIG. 5, and left side in FIG. 6). This developing cartridge storage unit 150a is formed such that it is opened upwards at the front side of the photosensitive unit frame 151. Also, the photosensitive drum 152 and the transfer roller 154 are stored in the space enclosed by the bottom wall unit 151b and the upper wall unit 151c.

A guide groove 151a1 is formed at the pair of side wall units 151a. With reference to FIG. 2, this guide groove 151a1 is configured such that it can contain the alignment collar 146 that is installed at both edges of the developing roller rotary driving shaft 144a. This guide groove 151a1 is configured so that when the developing cartridge 140 is installed in the photosensitive unit 150, the installation direction of the developing cartridge 140 can be guided by guiding the movement of the alignment collar 146. Also, the guide groove 151a1 is configured so that when it is engaged with the alignment collar 146, the developing cartridge 140 and the photosensitive unit 150 can be aligned. With reference to FIG. 6, an edge portion 151a2 at the deepest side of the guide groove 151a1 is formed to be almost straight in order to perform the alignment.

With reference to FIG. 5 and FIG. 6, an urging mechanism 131 is installed inside of the pair of side wall units 151a. Guide holes 151a3 that are relatively large through holes are formed respectively at the pair of side wall units 151a so that a part of the urging mechanism 131 (a moving active unit 131b1 as will be explained later) is exposed to the outside.

A guide protrusion 151d protrudes from outside of the pair of side wall units 151a. The protrusion 151d is formed such that when the photosensitive unit 150 is attached to and detached from the body frame 111 (See FIG. 1) in the body portion 110 in the monochrome laser printer 100, it can be guided on the guiding surface formed on the internal surface at both sides of the body frame 111.

At the bottom of the photosensitive unit frame 151, the resist facing roller 155 is supported in a freely rotatable manner almost at the center portion in the paper feed direction.

A lock mechanism 156 is provided on the internal side of one of the side wall units 151a (right side in FIG. 5) in the photosensitive unit frame 151. As shown in FIG. 6, the lock mechanism 156 is supported in a freely rotatable manner by the side wall unit 151a.

With reference to FIG. 2, the lock mechanism 156 is configured such that the upper end of the projecting portion 141e (See FIGS. 3A and 3B) in the developing cartridge case 141 is stopped from the upper side when the developing cartridge 140 is installed in the photosensitive unit 150. That is, the lock mechanism 156 is used to maintain the developing cartridge case 141 within the photosensitive unit frame 151 in order to prevent the developing cartridge case 141 from dissociating upwards from the photosensitive unit frame 151. Also, the lock mechanism 156 is configured such that the lock of the developing cartridge 140 relative to the photosensitive unit 150 can be released by pressing the lever operating unit 156a.

Again with reference to FIG. 5, multiple rollers 157 are disposed at the positions facing the developing cartridge storage unit 150a on the upper wall surface at the front side in the bottom wall unit 151b (lower side in the figure). The rollers 157 are installed at two positions at both the right and left sides of the developing cartridge storage unit 150a in this aspect. The rollers 157 are supported by the bottom wall unit 151b in a freely rotatable manner.

These rollers 157 are configured such that when storing the developing cartridge 140 (See FIGS. 3A and 3B) in the developing cartridge storage unit 150a, the bottom plate 141b of the developing cartridge case 141 is received and rotated so that a portion of the weight of the developing cartridge 140 can be received as well as guiding the attachment and detachment of the developing cartridge 140.

Detailed Configuration of the Urging Mechanism

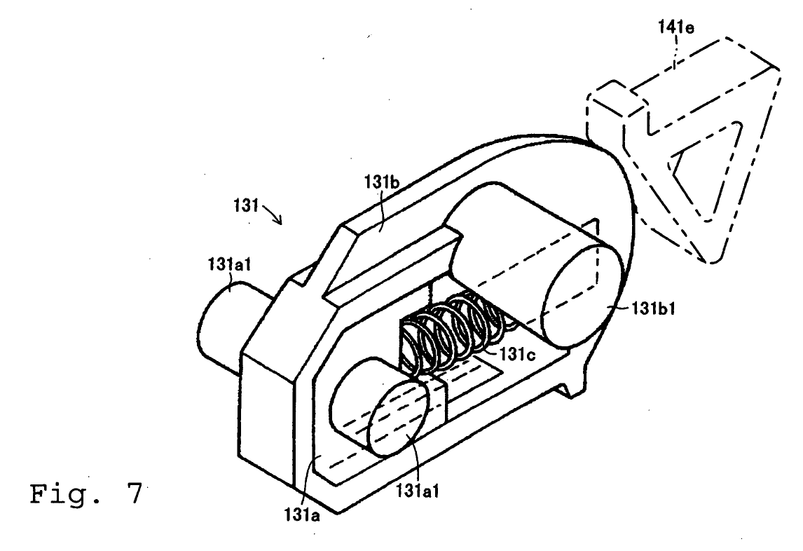

FIG. 7 is an enlarged perspective view of the urging mechanism 131 shown in FIG. 6.

With reference to FIG. 6 and FIG. 7, the urging mechanism 131 includes a rotation fulcrum member 131a, a slide supporting member 131b, and an urging spring 131c.

At the side of the rotation fulcrum member 131 a is a rotation axis 131a. The rotation axis 131a1 is supported by the side wall unit 151a in a freely rotatable manner. The rotation fulcrum member 131a is supported in a freely sliding manner inside of the slide supporting member 131b.

The slide supporting member 131b is formed in a frame shape having a space inside. In this inner space, the rotation fulcrum member 131a and the urging spring 131a are stored. Also, a columnar moving action unit 131b1 is integrally formed extending in the side direction from the slide supporting member 131b. The moving action unit 131b protrudes outside of the side wall unit 151a in the photosensitive unit frame 151 via the guide holes 151a3.

The urging spring 131c includes coil springs. The urging spring 131c is arranged to bridge one end in the space inside of the slide supporting member 131b and the rotation fulcrum member 131a. The urging spring 131c is configured and arranged such that the one end of the slide supporting member 131b can be urged in a direction away from the rotation fulcrum member 131a, that is in a direction towards the projecting portion 141e.

Detailed Configuration Regarding Pressing and Supplying Power to the Development Cartridge

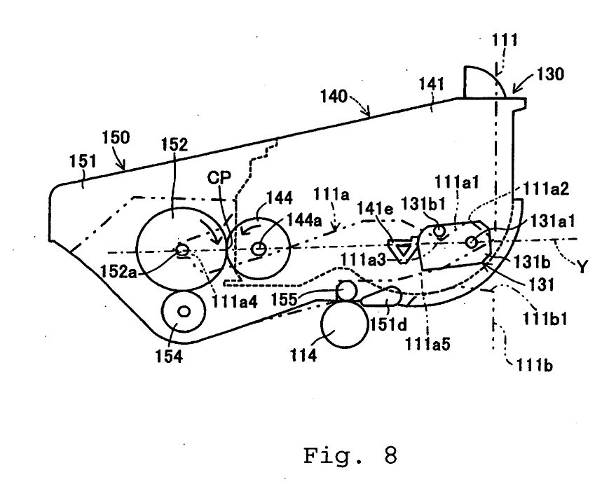

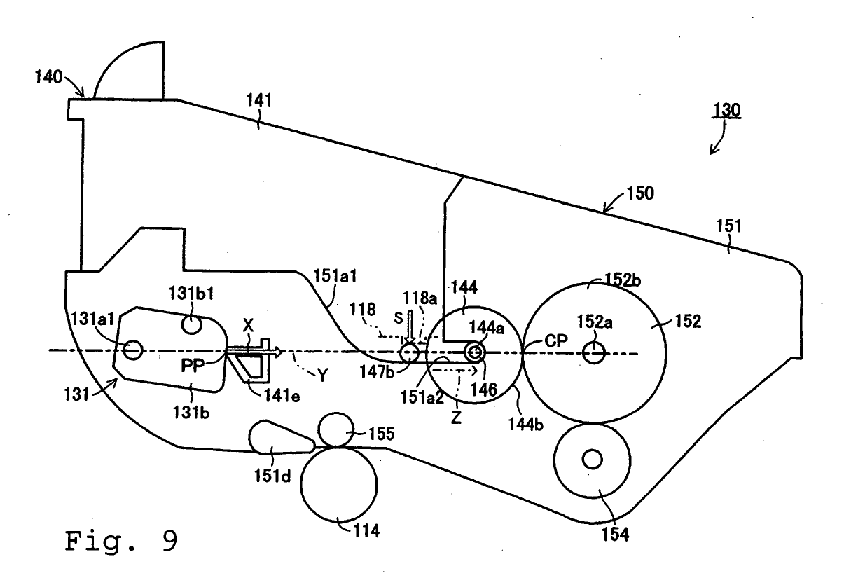

FIG. 8 is a schematic view from the side in order to explain the status of installations of the body frame 111 and the process cartridge 130 shown in FIG. 1. FIG. 9 is an enlarged view of the process cartridge 130 shown in FIG. 8. That is, it shows how the process cartridge 130 is installed in the body frame 111 in order to start an image forming operation.

With reference to FIG. 8, in the body frame 111, an upper guide protrusion 111a and a lower guide protrusion 111b are provided to be protruded in the lateral direction and inside.

The upper side guide surface 111al in the upper guide protrusion 111a is formed such that the drum shaft 152a in the photosensitive drum 152 and the moving action unit 131b in the urging mechanism 131 can be guided. That is, the edge of the front side in the upper side guide surface 111a1 is formed when installing the process cartridge 130 in the body frame 111 to perform specific pressing operations to the urging mechanism 131 by guiding the moving action unit 131b. Also, the edge of the back side in the upper side guide surface 111a1 is formed when installing the process cartridge 130 in the body frame 111 such that the photosensitive drum 152 is arranged at a specific position in the body frame 111 by guiding the drum shaft 152a.

Specifically, in the upper side guide surface 111a1, an upper side guide peak 111a2, an upper side guide concavity 111a3, and a drum shaft storage unit 111a4 are formed.

The upper side guide peak 111a2 and the upper side guide concavity 111a3 are formed at an edge of the front side in the upper side guide surface 111a1. The upper side guide concavity 111a3 is formed to contain the moving action unit 131b1 advancing to the back side beyond the upper guide peak 111a2. Since the moving action unit 131b1 is contained in the upper side guide concavity 111a3, the urging mechanism 131 can press the projecting portion 141e installed in the developing cartridge case 141 in a specific direction. The drum shaft storage unit 111a4 is in contact with the drum shaft 152a at the edge of the back side in the upper guide surface 111a1 that is formed in order to contain the drum shaft 152a.

A guide groove that can guide the guide protrusion 151d in the photosensitive unit frame 151 is formed between the mid guide surface 111a5, which is the surface at the opposite side (lower side) to the upper side guide surface 111a in the upper guide protrusion 111a, and the lower side guide surface 111b1 that is the upper side surface in the lower side guide protrusion 111b.

With reference to FIG. 9, in the state that the developing cartridge 140 is installed in the photosensitive unit 150 so that image forming operation can be performed, the projecting portion 141e installed in the developing cartridge case 141 is urged in the developing cartridge pressing direction X as indicated by the arrow in the figure at the pressing position PP by the slide supporting member 131b of the urging mechanism 131 installed in the photosensitive unit frame 151. The developing cartridge pressing direction X is specifically a direction towards the pressing position PP from the rotation axis 131a1. The alignment collar 146 installed at both ends of the developing roller driving shaft 144a is in contact with the edge portion 151a2 in the guide groove 151a1 formed at the side wall unit 151a of the photosensitive unit frame 151 due to this force.

By bringing the alignment collar 146 in contact with the edge portion 151a2, an alignment is made between the developing roller driving shaft 144a and the drum shaft 152a. That is, the toner carrying surface 144b of the developing roller 144 is in contact with the image carrying surface 152b of the photosensitive drum 152 at the contact point CP in a specific mode (pressure). The contact point CP is formed on the line drawn by connecting the center of the developing driving shaft 144a and the center of the drum shaft 152a. The contact point CP is also called a “developing position.”

As shown in FIG. 9, the pressing action line Y that connects the pressing point PP and the contact point CP is formed parallel to the guiding direction Z wherein the alignment collar 146 (developing roller driving shaft 144a) moves along the edge portion 151a2 in the guide groove 151a1 in this aspect. Also, in this aspect, the power supply protrusion 147b is arranged to cross with the pressing action line Y.

A power supply member 118 is arranged to be in contact with the power supply protrusion 147b. The power supply member 118 is formed by bending a conductive material such as wire in a rectangular shape in this illustrative aspect. In the power supply member 118, a power supply facing portion 118a that faces the power supply protrusion 147b is formed in a flat shape. The power supply member 118 is installed at the body frame 111 of the monochrome laser printer 100 (See FIG. 1) or in the photosensitive unit frame 151.

When the power supply facing portion 118a and the power supply protrusion 147b are in contact with each other while the power supply facing portion 118a in the power supply member 118 presses the power supply protrusion 147b, the power supply member 118 and the power supply protrusion 147b are electrically connected. That is, a specific developing bias voltage is applied between the developing roller 144 and the photosensitive drum 152 via the power supply member 118 and the power supply protrusion 147b.

In this aspect, the process cartridge 130 and the power supply member 118 are configured such that the power supply pressing direction S, which is the direction in which the power supply member 118 presses the power supply protrusion 147b, is perpendicular to the pressing action line Y and the longitudinal direction of the developing roller driving shaft 144a. Also, in this aspect, the process cartridge 130 and the power supply member 118 are configured such that the power supply pressing direction S is perpendicular to the guiding direction Z. Furthermore, in this aspect, the power supply member 118 is configured such that the power supply facing portion 118a becomes parallel to the guiding direction Z.

Overview of the Image Forming Operation Using a Laser Printer

An overview of the image forming operation using a monochrome laser printer 100 having the aforementioned configuration is explained below with reference to FIG. 1.

Operation of Paper Supply

Sheets of paper are stored in a stacked state in a feeder case 121. Sheets are urged upward to the sheet supply roller 113 by the sheet pressing plate 122. As a result, the top sheet in the feeder case 121 is in contact with the surface of the sheet supply roller 113.

When the sheet supply roller 113 is rotated in a counter-clockwise direction in FIG. 1, the tip of the top sheet moves towards the right side. Of course, due to friction among the sheets, not only the top sheet, but also several sheets underneath may also move towards the right side along with the top sheet. In this case, the tips of the several sheets from the top sheet in the feeder case 121 are pinched between the sheet supply roller 113 and the separation pad 123.

When the sheet supply roller 113 is further rotated in a counter-clockwise in the figure, only the top sheet P is separated due to the difference between the friction force among the sheets P and the friction force between the sheet P and the separation pad 123 that is supplied in the paper feed direction. Subsequently, the top sheet is conveyed towards the resist position where the resist facing roller 155 and the resist roller 114 are in contact with each other.

When the tip of the sheet is pushed to the resist position, the inclination of the sheet is corrected. Subsequently, the resist roller 114 is rotated at a specific timing. Along with the rotation of the resist roller 114, a resist facing roller 155 is rotated. As a result, the sheet is conveyed towards the transfer position, which is the position at which the photosensitive drum 152 faces with the transfer roller 154. In this manner, the inclination of the sheet is corrected and the conveyance timing is adjusted.

Subsequently, the sheet enters the process cartridge 130. A toner image is formed (transferred) on the upper surface of the sheet at the transfer position in the process cartridge 130.

Formation of Electrostatic Latent Images

While the sheet is conveyed to the transfer position as mentioned above, a toner image is carried as described below on the surface of the photosensitive drum 152.

The surface of the photosensitive drum 152 is initially charged uniformly by the charger 153. The surface of the photosensitive drum 152 charged by the charger 153 is rotated in the direction shown by the arrow in figure showing the photosensitive drum 152 (clockwise direction). During this rotation, a laser beam is emitted by the scanner unit 160 to the surface. This laser beam is scanned along the lateral direction by the rotation of the polygon mirror 162. Also, the laser beam is produced based on the image data. That is, the emission status of the laser beam (ON/OFF pulse shape) is modulated according to the image data.

When the modulated laser beam is scanned on the surface of the photosensitive drum 152, electrostatic latent images are formed on the surface. The surface of the photosensitive drum 152 wherein electrostatic latent images are formed is rotated in the direction indicated by the arrows in the figure (clockwise direction) and carried to the position of which it is in contact with or closely in contact with the surface of the developing roller 144.

Developing the Electrostatic Latent Images and Transferring the Toner Images

As mentioned above, the developing roller 144 and supply roller 143 are rotated in the direction indicated by the arrows in the figure (counterclockwise direction).

At the point when the surface of the developing roller 144 is in contact with the supply roller 143, there is friction between the two rollers. Due to this friction, charged toners are carried on the surface of the developing roller 144. Subsequently, when the toner layer thickness regulating blade 145 is in contact with the developing roller surface, an amount of toner to be carried on the surface is set at a specified value.

The surface of the developing roller 144 on which a specific amount of toner is carried is rotated in the direction indicated by the arrow (counterclockwise direction) in the figure to reach such a position that it faces the photosensitive drum 152.

When the surface of the photosensitive drum 152 on which electrostatic latent images are formed is brought into contact with the surface of the developing roller 144 carrying the charged toner, the toner adheres to the surface in the pattern corresponding to the electrostatic latent images formed on the surface of the photosensitive drum 152. That is, the electrostatic latent images on the surface of the photosensitive drum 152 are developed by the toner and the toner images are transferred to the surface.

As described above, the toner images carried on the surface of the photosensitive drum 152 are conveyed towards the transfer position by rotating the surface in a clockwise direction in the figure. Subsequently, the toner images are transferred at the transfer position from the surface of the photosensitive drum 152 to a sheet of paper.

Fixing/Sheet Delivery

The sheet on which the toner images are formed (transferred) at the transfer position as described above is discharged from the process cartridge 130. Subsequently, the sheet on which the toner images have been transferred is carried along the paper feed passage PFP to a fixing unit 170. The sheet on which the toner images have been transferred is heated while being pressed when it is inserted into the space between the heat roller 171 and the pressure roller 172. As a result, toner images are fixed on the surface of the sheet.

Subsequently, the sheet after completing the fixing process is carried in the paper feed direction by rotating the heat roller 171 and the pressure roller 172 in the direction indicated by the arrow in the figure. While guided with the paper guide 115, the sheet is sent towards the space between the paper exit roller 116 and the paper exit sub-roller 117.

Subsequently, when the paper exit roller 116 is rotated in a counterclockwise direction in the figure, the fixed paper is discharged from the paper exit outlet 112b2 to the paper exit tray 112b1.

Installation of a Developing Cartridge in the Photosensitive Unit

Installation of the developing cartridge 140 in the photosensitive unit 150 is described below with reference to FIG. 4 through FIG. 6.

A developing cartridge 140 is inserted from the side of the developing roller 144 relative to the developing cartridge storage unit 150a that is formed to open towards the upper side at the front side of the photosensitive unit frame 151. That is, the developing cartridge 140 is inserted into the developing cartridge storage unit 150a such that the alignment collar 146 is inserted into the groove 151a1. While the alignment collar 146 slides with the guide groove 151a, it is guided towards the drum shaft 152a due to the guide groove 151a. Also, the bottom surface of the developing cartridge case 141 is in contact with the roller 157.

The developing roller driving shaft 144a can be rotated smoothly within the alignment collar 146. When the alignment collar 146 reaches the edge portion 151a2 at the deepest section in the guide groove 151a1, the developing cartridge 141 is stored in the developing cartridge storage unit 150a by rotating downwards around the developing roller driving shaft 144a and the alignment collar 146 as the center.

As mentioned above, the movement of the developing cartridge case 141 in the developing cartridge storage unit 150a can be guided smoothly in such a direction that the developing roller 144 approaches the photosensitive drum 152. Subsequently, the alignment collar 146 is guided along the specific guiding direction (guiding direction Z in FIG. 9) by the edge portion 151a2 in the guide groove 151a.

When the alignment collar 146 is in contact with the edge portion 151a2, the developing roller 144 and the photosensitive drum 152 are aligned. As a result, the toner carrying surface 144b in the developing roller 144 and the image carrying surface 152b in the photosensitive drum 152 are brought into contact in a specific mode. Also, when the alignment collar 146 is in contact with the edge portion 151a2, the developing cartridge case 141 is locked by the lock mechanism so that it is not thrown out from the developing cartridge storage unit 150a.

In contrast, when detaching the developing cartridge 140 from the photosensitive unit 150, the lever operation unit 156a is pressed down in the lock mechanism 156. As a result, the lock for the developing cartridge case 141 due to the lock mechanism 156 is released. Subsequently, due to relative rotation between the developing roller driving shaft 144a and the alignment collar 146 and smooth sliding between the alignment collar 146 and the guide groove 151a, the movement of the developing cartridge 140 is smoothly guided into the photosensitive unit 150. As a result, the developing cartridge 140 can be easily detached from the photosensitive unit 150.

Installation of the Process Cartridge in the Body Frame

Subsequently, installation of the process cartridge 130 assembled by installing the developing cartridge 140 in the photosensitive unit 150 in the body frame 111 is described below with reference to FIG. 8 through FIG. 10.

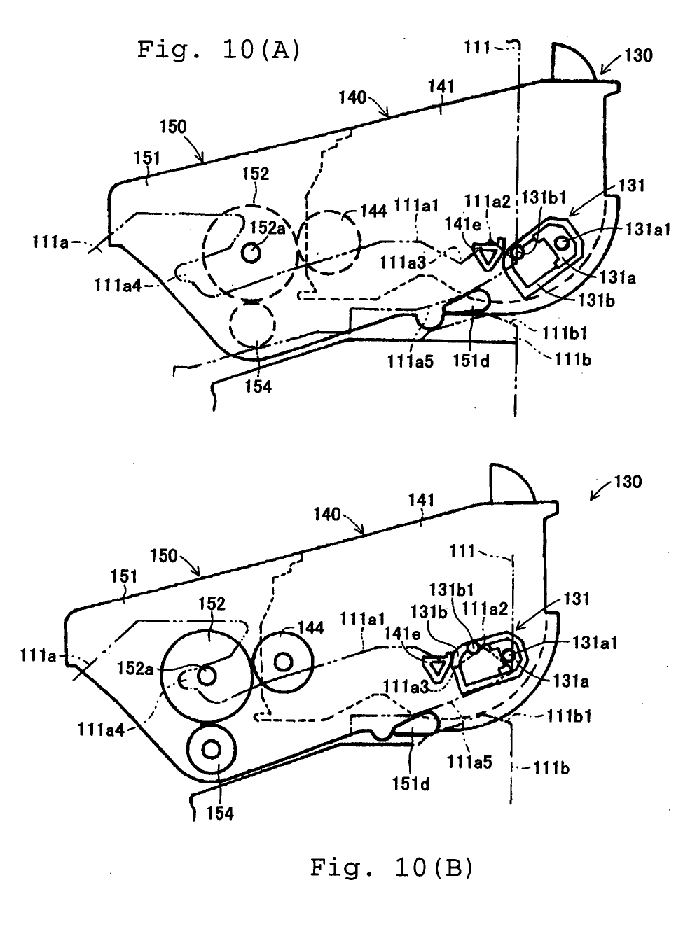

With reference to FIG. 10A, at the initial period when installing the process cartridge 130 in the body frame 111, the slide supporting member 131b in the urging mechanism 131 rotates downwards due to its own weight around the rotary axis 131a1 in the rotary fulcrum member 131a in order to be in a hung down state.

Also, the guide protrusion 151d in the photosensitive unit frame 151 is inserted into the opening portion (right side end in the figure) of the guide groove formed between the mid guide surface 111a5 in the upper side guide protrusion 111a and the lower side guide surface 111b1 in the lower side guide protrusion 111b. As a result, the ascending position of the process cartridge 130 is regulated by the mid guide surface 111a5. The process cartridge 130 is inserted downwards diagonally to the left along the mid guide surface 111a5 and the lower side guide surface 111b1 in such a state that passing upwards in the figure is prevented.

When the process cartridge 130 is moved to the left in FIGS. 10A and 10B and inserted into the inside of the body frame 111, as shown in FIG. 10A, the movement action unit 131b in the urging mechanism 131 is in contact with the starting inclined surface at the front side of the upper guide peak 111a2 in the upper side guide surface 111a1. As a result, the slide supporting member 131b in the urging mechanism 131 starts rotating upwards in the figure around the rotary axis 131a1. Due to this rotation, the slide supporting member 131b comes in contact with the projecting portion 141e in the developing cartridge case 141 in order to start urging the projecting portion 141e.

When the process cartridge 130 is further inserted in the body frame 111, the slide supporting member 131b further moves upwards, and the projecting portion 141e in the developing cartridge case 141 is further pressed by a greater force due to the slide supporting member 131b than that in the state shown in FIG. 10A. Then, the movement action unit 131b1 reaches right above the upper side guide peak 111a2 in the upper side guide surface 111a1. In this state, the projecting portion 141e pressed by the slide supporting member 131b becomes the maximum. In this case, the slide supporting member 131b is in such a state that it is slightly inclined downwards from the horizontal level (the free end side of the slide supporting member 131b is slightly lower than the rotary axis 131a1).

Subsequently, as shown in FIG. 10B, the movement action unit 131b1 crosses over the upper guide peak 111a2. In this state, the movement action unit 131b1 is elastically urged in the direction away from the rotary fulcrum member 131a so that the slide supporting member 131b rotates downwards due to this urging force around the rotary axis 131a1. Also, the force between the slide supporting member 131b and the projecting portion 141e is slightly more relaxed than that in the state when the movement action unit 131b1 is immediately above the upper guide peak 111a2. Therefore, the movement action unit 131b1 crosses the upper guide peak 111a2 so that the force in the direction contained in the upper guide concavity 111a3 is generated in a stable manner.

In the aspect, as mentioned above, as the process cartridge 130 is inserted (movement by pushing downwards in a diagonal direction) the movement action unit 131b1 is pushed up by the upper guide surface 111a. Subsequently, the slide supporting member 131b rotates upwards around the rotary axis 131a1. In this case, the process cartridge 130 is regulated for elevation due to the mid guide surface 111a5. As a result, while the process cartridge 130 is inserted, the operation, of which the projecting portion 141e in the developing cartridge 141 is pressed by the slide supporting member 131b, is maintained without being cancelled.

When the process cartridge 130 is further pushed and the operator releases the hands from the process cartridge 130 in such a state that the drum shaft 152a is in contact with the drum shaft storage unit 111a4, as shown in FIG. 8, the operation of installation of the process cartridge 130 into the body frame 111 is completed. In this state, due to the weight of the process cartridge 130, the resist facing roller 155 supported at the bottom of the photosensitive unit frame 151 is placed on the resist roller 114. Also, the movement action unit 131b1 is maintained at the lowest position of the upper guide concavity 111a3. Moreover, the guide protrusion 151d is supported at the specific location in the guide groove formed between the mid guide surface 111a5 and the lower side guide surface 111b1. Therefore, the state wherein the developing cartridge 140 is pressed against the photosensitive drum 152 is maintained while the process cartridge 130 can be stably supported by the body frame 111.

As explained above, in the state wherein the process cartridge 130 is installed in the body frame 111, as shown in FIG. 9, the developing cartridge case 141 is pressed in the developing cartridge pressing direction as indicated by the arrow X in FIG. 9 against the photosensitive drum 152 by the urging mechanism 131 and the projecting portion 141e. As a result, the toner carrying surface 144b on the developing roller 144 and the image carrying surface 152c on the photosensitive drum 152 are in contact in a specified mode at the contact point CP.

The developing cartridge pressing direction X shares the same axis as the pressing action line Y. Also, the developing cartridge pressing direction S and the pressing action line Y are parallel to the guiding direction Z.

Also, the power supply protrusion 147b is pressed in the power supply pressing direction S by the power supply member 118. As a result, power is supplied from the power supply member 118 via the power supply protrusion 147b to the developing cartridge 140. In addition, a specific developing bias voltage is applied at the contact point CP (developing position). In this case, the power supply pressing direction S, in which the power supply member 118 presses the power supply protrusion 147b, is almost perpendicular to the developing cartridge pressing direction X, the pressing action line Y, and the guiding direction Z.

Actions and Effects of the Configuration of Aspects

Next, the actions and effects of the configuration of the aforementioned aspects are described below with references to the drawings.

In some aspects, the conductive member 147 is configured such that the power supply member 118 for applying a developing bias to the developing roller 144 and the developing roller driving shaft 144a are electrically connected. The power supply protrusion 147b in the conductive member 147 is configured to be exposed to the outside from the photosensitive unit frame 151. When the developing cartridge 140 is installed in the body frame 111, the power supply protrusion 147b is perpendicular to the longitudinal direction of the developing roller driving shaft 144a of the developing roller 144 (rotary axial line) by the power supply part 118, and it is arranged to be pressed in a direction perpendicular to the developing cartridge pressing direction X.

Therefore, the force from the power supply member 118 to the power supply protrusion 147b does not act in the developing cartridge pressing direction X. Thus, the developing cartridge 140 is stable without being damaged and is maintained in the photosensitive unit 150. Therefore, this can prevent the contact state between the photosensitive drum 152 and the developing roller 144 from becoming unstable, maintaining high image quality.

Also, the power supply protrusion 147b is arranged to be perpendicular to the rotary axial line of the developing roller 144 by the power supply member 118, and to be pressed in the direction perpendicular to the pressing action line Y (pressing action direction) connecting the pressing position PP and the contact position CP.

The force applied by the power supply member 118 to the power supply protrusion 147b does not act in the pressing action direction. Therefore, the contact state between the photosensitive drum 152 and the developing roller 144 is stabilized, achieving high image quality.

The power supply protrusion 147b is arranged to be pressed by the power supply member 118 on the pressing action line. Therefore, damage to the developing cartridge 140 can be prevented. Thus, the contact state between the photosensitive drum 152 and the developing roller 144 becomes more stable and further improvement in image quality is assured.

In some aspects, at the upper edge of both left and right side wall units 151a of the photosensitive unit frame 151, when installing the developing cartridge 140 in the photosensitive unit 150, a guide groove 151a1 is formed in order to guide the developing roller driving shaft 144a (alignment collar 146). When the developing cartridge 140 installed in the body frame 111 is pressed by the urging mechanism 131, the developing roller 144 is pressed in contact with the photosensitive drum 152 while the developing roller driving shaft 144a moves along the edge portion 151a2 at the deepest part of the guide groove 151a1.

In these aspects, the power supply protrusion 147b of the conductive member 147 is perpendicular to the rotary axial line of the developing roller 144 by the power supply member 118, and the guide groove 151a1 at the deepest side (edge portion 151a2) is pressed in the direction perpendicular to the guiding direction Z for guiding the developing roller driving shaft 144a. Thus, the force applied by the power supply member 118 to the power supply protrusion 147b does not have any effect on the guiding direction Z at the deepest side. Therefore, the effects of the pressure by the power supply member 118 to the power supply protrusion 147b on the contact of the developing roller 144 to the photosensitive drum 152 at the contact position CP can be absolutely minimized. As a result, while damage to the developing cartridge 140 is depressed, a specific contact state of the developing roller 144 with the photosensitive drum 152 at the contact position CP can be absolutely maintained in a stable manner so that higher image quality can be maintained.

According to these aspects, the power supply facing portion 118a in the power supply member 118 is parallel to the guiding direction Z. As a result, a satisfactory electrical contact state between the power supply facing portion 118a and the power supply protrusion 147b can be formed at an early stage, while force can be applied to the contact position CP of the developing roller 144.

Example of Modified Case of the Above Aspects

According to certain aspects, the power supply protrusion 147b of the conductive member 147 can be arranged on the pressing action line connecting the pressing position PP and the contact position CP as shown in FIG. 9. Of course, the positions where the conductive member 147 and the power supply protrusion 147b are arranged are not limited by these examples. That is, any pressing positions are applicable as long as they are perpendicular to the axial line of the developing roller 144 by the specified power supply member, in the direction perpendicular to the developing cartridge pressing direction X of the urging mechanism 131, and in the direction perpendicular to the pressing action line Y (pressing action direction) connecting the pressing positions PP and the contact position CP.

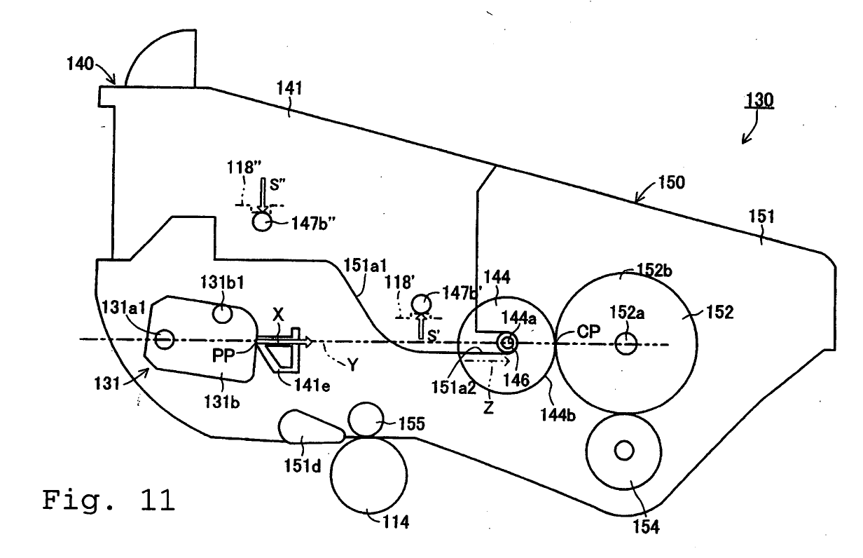

For example, as shown in FIG. 11, the power supply protrusion 147b′ and the power supply protrusion 147b″ can be arranged at positions that are away from the pressing action line Y.

The power supply protrusion 147b can be arranged perpendicular to the axial line of the developing roller 144, or can be arranged in the direction perpendicular to one of the following directions: developing cartridge pressing direction X or the pressing action line Y connecting the pressing position PP and the contact position CP (pressing action direction). In this case, the contact of the power supply member 118 to the conductive member 147 has little effect on the developing cartridge pressing direction X or pressing action direction. Thus, damage to the developing cartridge 140 can be prevented. Therefore, the contact of the developing roller 144 with the photosensitive drum 152 at the contact position CP can be maintained in a stable manner, keeping the high image quality.

According to some aspects, the power supply pressing direction S by the power supply member 118 to the power supply protrusion 147b is set in an up and down direction. Of course, as shown in FIG. 11, the power supply member 118′ can press the lower side of the power supply protrusion 147b. That is, the power supply pressing direction S′ can be the up and down direction. Moreover, as shown in FIG. 11, an upward power supply pressing direction S′ by the power supply member 118′ and the downward power supply pressing direction S″ by the power supply member 118″ can be both present.

The power supply member 118 can be formed by bending a conductive line material such as wire into a rectangular shape. The power supply protrusion 147b can be pressed by the power supply facing portion 118a, which includes a flat portion. Of course, the power supply member 118 can be formed in any shape other than that mentioned above as long as it can press against the power supply protrusion 147b in a stable manner.

According to some aspects, the urging mechanism 131 can be provided in the photosensitive unit 150. Also, when the photosensitive unit 150 is inserted in the body frame 111, the moving action unit 131b1 of the urging mechanism 131 can be guided on the guiding surface formed on the interior surface at both left and right sides of the body frame 111. In addition, when the tip of the slide supporting member 131b presses the projecting portion 141e in the developing cartridge 140, the developing roller 144 presses against the photosensitive drum 152 via the developing cartridge 140.

Of course, the configuration for pressing the developing cartridge 140 is not limited by these examples. For example, an urging mechanism can be provided at the side of the body frame 111 rather than the photosensitive unit 150, and the developing roller 144 can be urged against the photosensitive drum 152 by the urging mechanism directly pressing the developing cartridge 140.

Moreover, the power supply member 118 for applying a developing bias to the developing roller 144 can be installed in the body frame 111. Alternatively, a cable electrode that is in contact with the specific output electrode installed in the body frame 111 can be installed in the photosensitive cartridge. In this case, this cable electrode functions as a power supply member.

The monochrome laser printer 100 according to some aspects can be configured such that after forming the process cartridge 130 by pre-installing the developing cartridge 140 in the photosensitive unit 150, the process cartridge 130 can be attached to and detached from the body frame 111. Of course, instead of this configuration, the developing cartridge 140 and the photosensitive unit 150 can be individually installed in a freely attachable and detachable manner to the body frame 111. In this case, the guide groove 151a1 for guiding the alignment collar 146 in a freely sliding matter has bearings at both ends of the developing driving shaft 144a protruding outwards at both sides of the developing cartridge 140 that can be formed in the body frame 111.

Overall Configuration of a Laser Printer According to an Illustrative Aspect

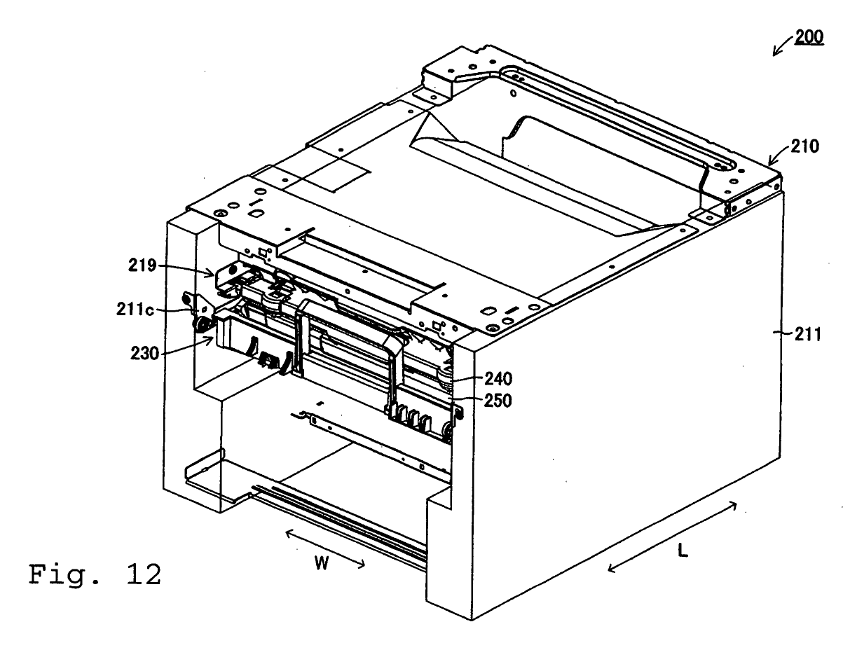

FIG. 12 is a perspective view of a color laser printer 200 of the image forming apparatus according to aspects of the present invention. FIG. 12 shows a state when the body cover is omitted as the external cover of the color laser printer. In the following explanation, the members having the similar structures and functions as in the aspects previously described have been expressed by the same symbols. For descriptions of the structures, actions and functions of these members, they can be appropriately employed in the range that the descriptions provided in previously described aspects are not technically redundant.

With reference to FIG. 12, the body frame 211 in the body portion 210 of the color laser printer 200 can contain the process unit 230 in a freely attachable and detachable manner. The process unit 230 may include multiple developing cartridges 240 and photosensitive units 250. The developing cartridge 240 is installed in the process unit 230 such that the longitudinal direction is parallel to the lateral direction of the color laser printer 200 (indicated by the arrow W in the figure). Multiple developing cartridges 240 and photosensitive units 250 are arranged along the front and back direction L.

A pair of slide guide frames 211c is installed on the wall surface inside of the body frame 211. The pair of slide guide frames 211c is configured to support the process unit 230 within the body frame 211. Also, the slide guide frame 211c is configured such that the process unit 230 can be attached to and detached from the body frame 211 by guiding along the front to back direction of the color laser printer 200 (indicated by the arrow L in the figure). The details of the configuration of the slide guide frame 211c will be discussed later.

On the wall surface inside of the body frame 211, a pair of linear cam mechanisms 219 is installed. Each linear cam mechanism 219 is configured such that multiple developing cartridges 240 that are oriented along the front to back direction L can be selectively pressed downward. The details of the configuration of a linear cam mechanism 219 will be discussed later.

The color laser printer 200 is configured such that using multiple developing cartridges 240 containing different types (colors) of toners, multiple types of toner images adhere on the surface of a recording medium (paper) and full color images are formed by fixing the images.

Overview of the Configuration of the Developing Cartridge

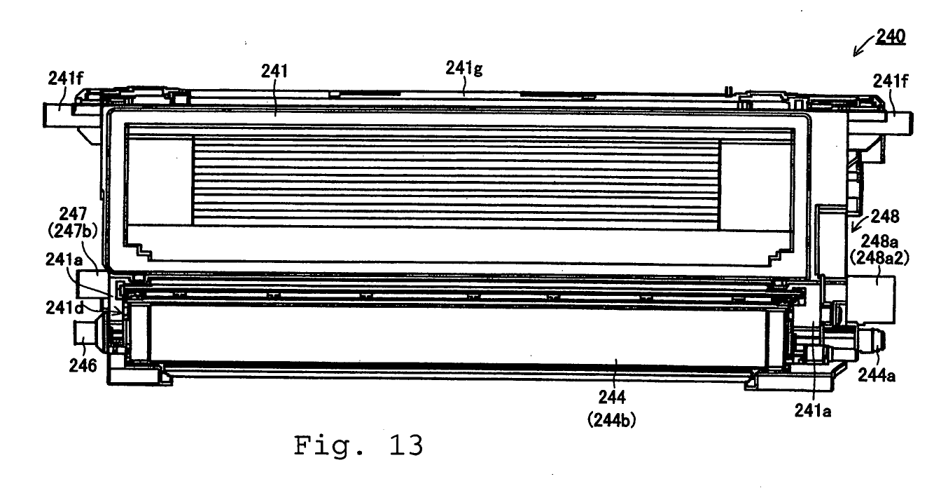

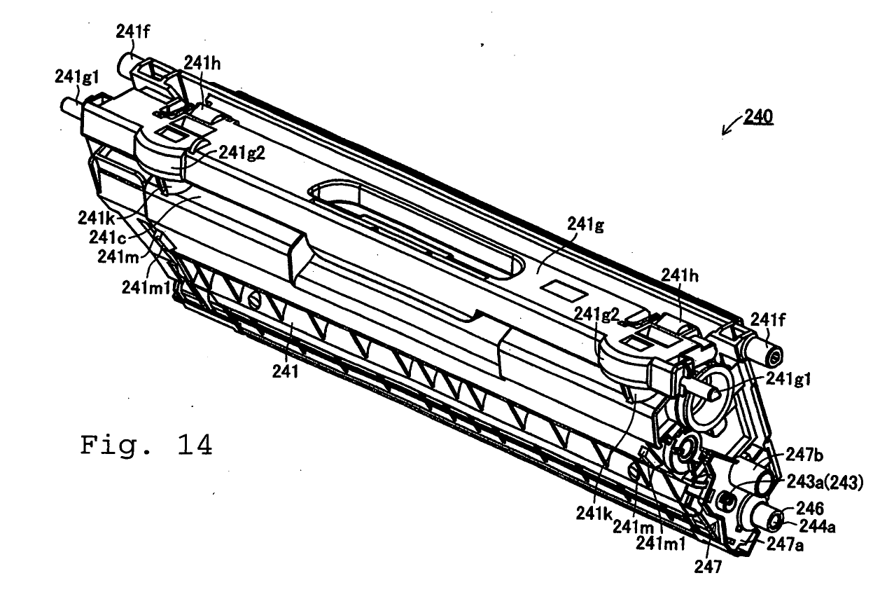

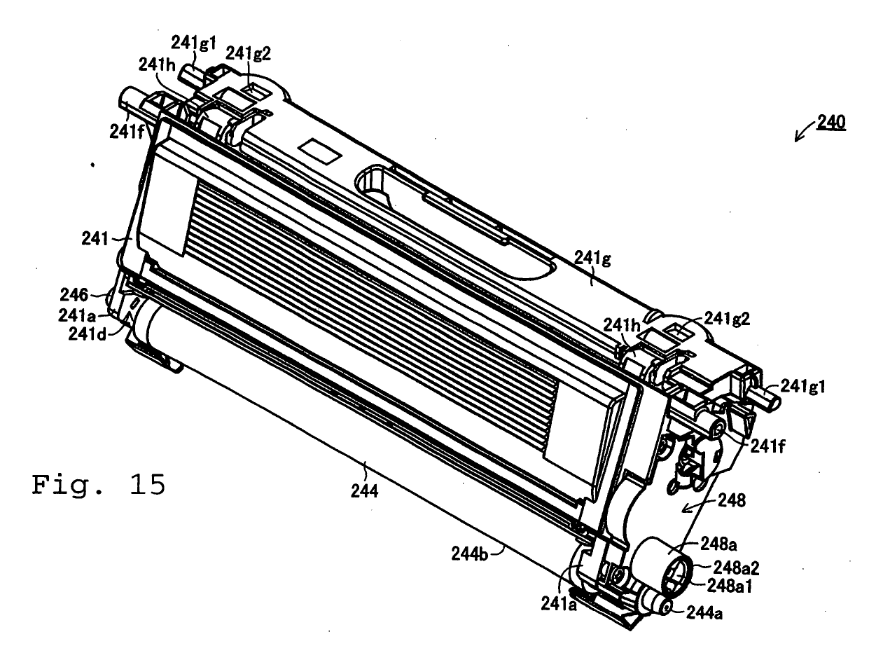

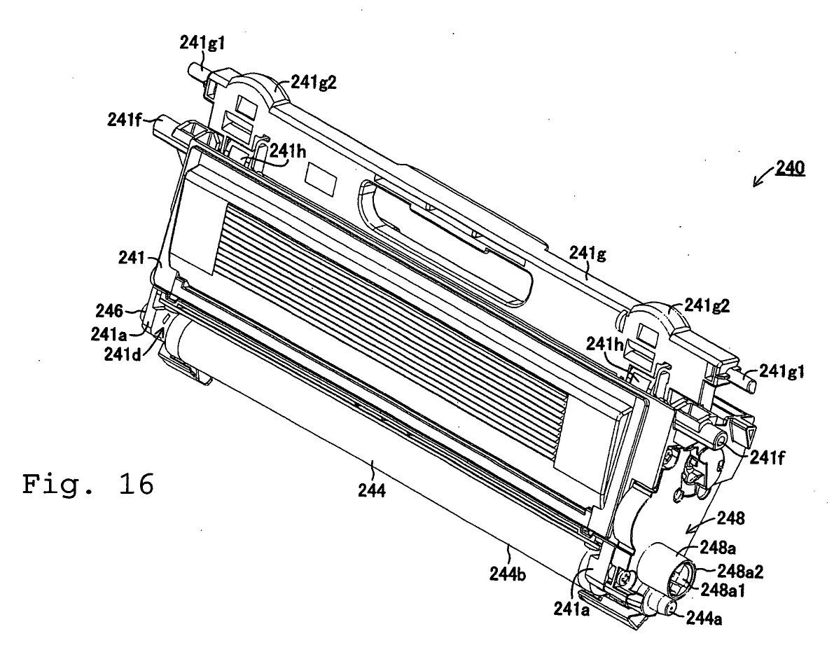

FIG. 13 is a front view of the developing cartridge 240 shown in FIG. 12 (view from the back side of FIG. 12). FIG. 14 is a perspective view seen from the rear side of the developing cartridge 240 shown in FIG. 13 (viewed from the front side in FIG. 12). FIG. 15 and FIG. 16 are perspective views seen from the front side of the developing cartridge 240 shown in FIG. 13 (viewed from the back side in FIG. 12).

With reference to FIG. 13, a developing roller 244 is stored in the developing cartridge case 241. The developing cartridge case 241 is configured such that a portion of the toner carrying surface 244b on the developing roller 244 is exposed to the outside via the developing opening 241d formed at the lower end portion. The developing roller driving shaft 244a including the central axis of the developing roller 244 is supported in a freely rotatable manner by the pair of side plates 241a in the developing cartridge case 241.

Configuration of the Conductive Member and the Driving Force Input Unit

At the end of the developing roller driving shaft 244a corresponding to one side plate 241a (left side in the figure), an alignment collar 246 is installed. A conductive member 247 is installed at the side plate 241a at the side where the alignment collar 246 is installed. A driving force input unit 248 is installed at the other side plate 241a (right side in the figure).

With reference to FIG. 14, the conductive member 247 includes a base plate 247a and a power supply protrusion 247b. The base plate 247a is configured in a flat plate form. In the base plate 247a, through-holes are formed such that the supply roller driving shaft 243a and developing roller driving shaft 244a are inserted. The base plate 247a is electrically connected by bringing the base plate in contact with the supply roller driving shaft 243a and developing roller driving shaft 244a.

The power supply protrusion 247b is installed such that it protrudes outwardly from the base plate 247a. The outer surface of the power supply protrusion 247b is formed in a cylindrical shape. That is, the outer shape of the power supply protrusion 247b is almost circular when viewed from the side along the lateral direction. The outer surface of the power supply protrusion 247b is made of a specific power supply member configured to be able to supply power and has a smooth cylindrical surface.

With reference to FIG. 15, the driving force input unit 248 includes a coupling unit 248a. The coupling unit 248a includes a coupling interlocking unit 248a1 and a coupling covering sleeve 248a2.

The coupling interlocking unit 248a1 is configured to interlock with a driving rotor installed at the side of the body frame 211 (See FIG. 12) to receive the driving force via the driving rotor. The coupling covering sleeve 248a2 is a thin film cylindrical member formed to protrude from the driving force input unit 248. The coupling interlocking unit 248a1 is included in a freely rotatable manner in the space inside of the coupling covering sleeve 248a2.

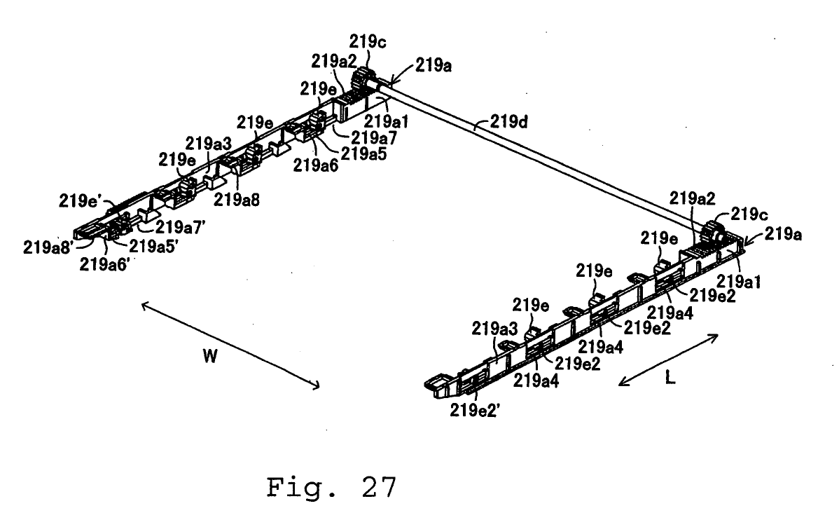

The outer shape of the coupling interlocking unit 248a1 is formed to be a circle having an outer diameter greater than the alignment collar 246 and the power supply protrusion 247b in the conductive member 247 when viewed from the side along the lateral direction. Specifically, the coupling interlocking unit 248a1 has an outer diameter that interlocks with the drum unit 250 (See FIG. 27) via the alignment collar 246 and an outer diameter that is approximately 1.5 times the outer diameter of the terminal unit 247b. Also, the outer shape of the coupling interlocking unit 248a1 is formed to include the outer diameter of the power supply protrusion 247b when viewed from the side along the lateral direction. That is, the outer shape of the coupling interlocking unit 248a1 is formed to include the power supply pressing position where the power supply protrusion 247b and the specific power supply member are in contact with each other when viewed from the side along the lateral direction.

Overview of the Configuration of the Developing Cartridge

Again, with reference to FIG. 14, in the ceiling plate 241c of the developing cartridge case 241, a pair of separation bosses 241f is formed in order to urge the developing cartridge 240 upwards when not forming images. The pair of separation bosses 241f is installed to protrude outside along the lateral direction at the front end in the ceiling plate 241c.

A handle 241g is installed in the ceiling plate 241c of the developing cartridge case 241. The handle 241g is supported in a freely rotatable manner by the hinge unit 241h installed at the front edge of the ceiling plate 241c. The handle 241g is turned to the standing state shown in FIG. 16 when attaching and detaching the developing cartridge 240 such that the operator can grip the handle portion. Also, the handle 241g is provided to urge the developing cartridge 241 downwards in a stored state as shown in FIG. 14 and FIG. 15 during the image forming operation.

With reference to FIG. 14, the handle 241g forms a pair of pressing bosses 241g1 in order to urge the developing cartridge case 241 downwards during the image forming operation. The pair of pressing bosses 241g1 is installed to protrude outside along the lateral direction at both ends at the free ends of the handle 241g. The pressing member 241g2 that is located inside in the lateral direction from the pressing bosses 241g1 is urged towards the urging mechanism 241k below low the pressing member 241g2 by pressing the pressing bosses 241g1 from the above.

The pair of urging mechanisms 241k is installed at the ceiling plate 241c of the developing cartridge case 241. In response to the pair of pressing members 241g2, the urging mechanism 241k is arranged at both ends in the lateral direction of the ceiling plate 241c. The urging member 241k urges the developing cartridge case 241 downwards to press the pressing member 241g2 downwards. The specific configuration of the urging 241k will be discussed later.

Above the back side of the developing cartridge case 241, a pair of guide protrusions 241 is formed. The guide surface 241m1 at the tip of the guide protrusions 241m is formed to be a flat surface.

Configuration for Detaching and Attaching the Developing Cartridge and the Photosensitive Unit

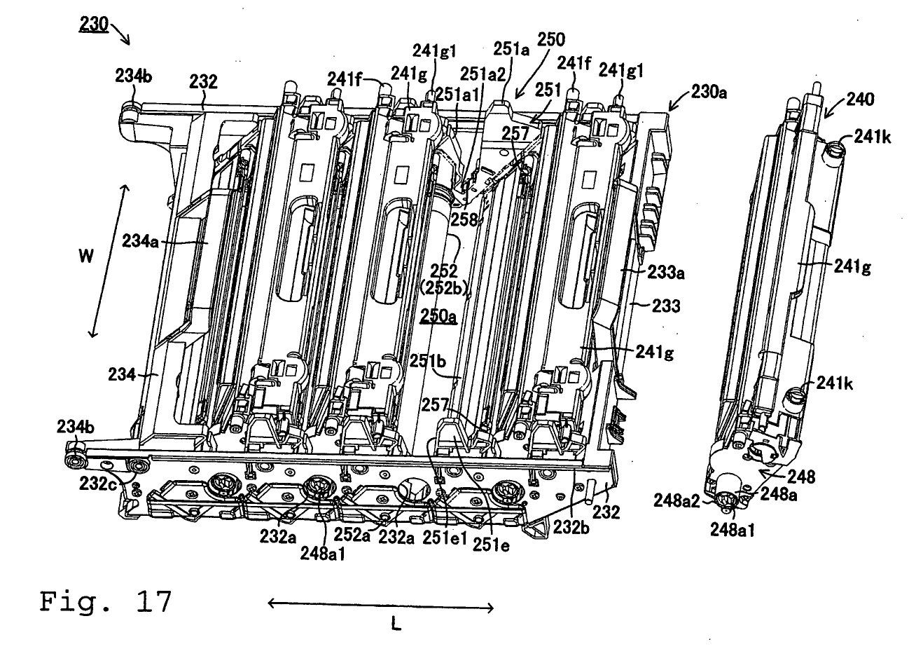

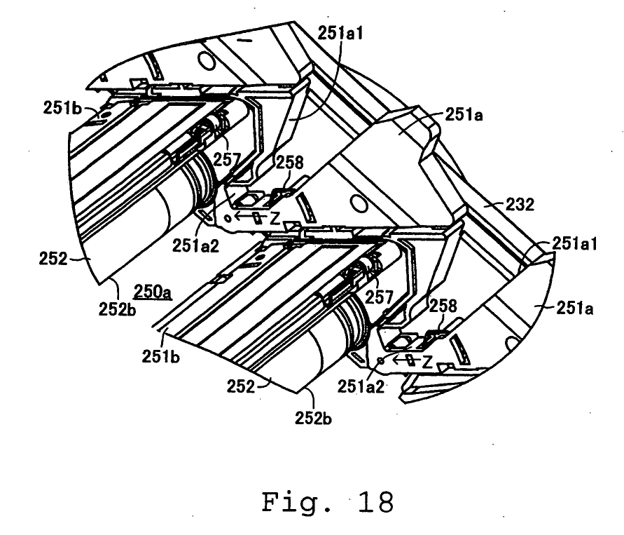

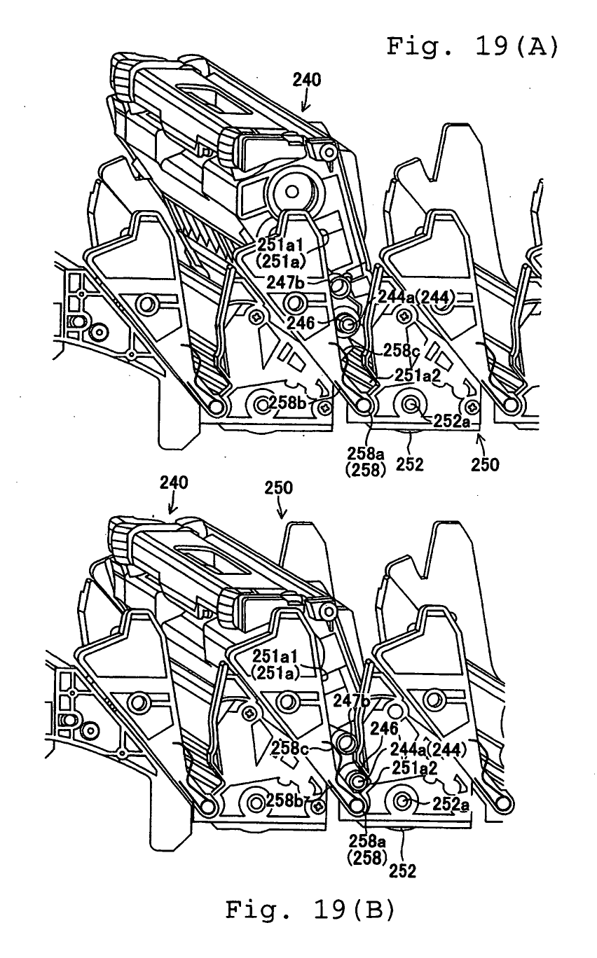

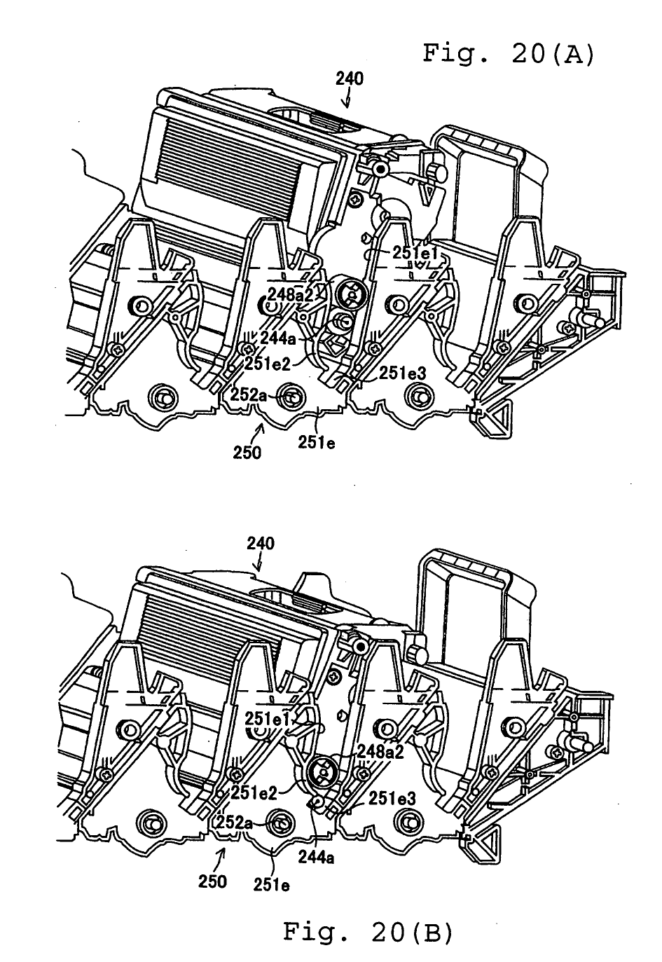

FIG. 17 is a perspective view showing the process unit 230 shown in FIG. 12. FIG. 17 shows a state when one of the four developing cartridges 240 is attached and detached. FIG. 18 is an enlarged perspective view for the key portion of the photosensitive unit 250 shown in FIG. 17. That is, FIG. 18 is a perspective view of one enlarged end in the lateral direction of the photosensitive unit 250 wherein a developing cartridge 240 is attached and detached in FIG. 17. FIG. 19 is a perspective view of the photosensitive unit 250 shown in FIG. 17 when viewed from the side. FIG. 20 is a perspective view of the photosensitive unit 250 shown in FIG. 17 when viewed from the opposite side from the case shown in FIG. 19. FIG. 19 and FIG. 20 show the state when the side frame 232 in FIG. 17 is seen.

With reference to FIG. 17, in the process unit 230, four sets of cartridges 240 and photosensitive units 250 are oriented along the front-to-back direction L. These developing cartridges 240 and the photosensitive units 250 are installed in the process unit frame 230a.

The process unit frame 230a includes a pair of side frames 232, a front beam 233, and a rear beam 234. The front beam 233 is arranged to cover the end of the front side (right side in the figure) in the pair of side frames 232. The rear beam 234 is arranged to cover the end of the back side (left side in the figure) in the pair of side frames 232. Four sets of photosensitive units 250 are fixed in the interior of the rectangular space enclosed by the pair of side frames 232, the front beam 233 and the rear beam 234. The developing cartridges 240 are installed in the process unit frame 230a via these photosensitive units 250.

In the almost central portion in the direction of height of the side frame 232, coupling exposure opening 232a is formed as a through-hole. The coupling exposure opening 232a is configured such that when the developing cartridge 240 is installed, the coupling unit 248a is exposed towards the side of the process unit frame 230a.

A guide rib 232b is formed at the upper end of the side frame 232. The guide rib 232b is installed to protrude towards the outside in the lateral direction W. This guide rib 232b is formed to have a longitudinal direction that is parallel to the front-to-back direction L. Immediately below the guide rib 232b and at the edge at the back side of the side frame 232, a side frame guide roller 232c is supported in a freely rotatable manner.

The side frame 232 is configured such that the process unit 230 can be attached and detached along the front-to-back direction L by sliding the guide rib 232b and the side frame guide roller 232c with the slide guide frame 211c (see FIG. 12) installed in the body frame 211.

A front beam grip 233a is formed at the upper end of the front beam 233 and at the center of the lateral direction W. Also a rear beam grip 234a is formed at the upper end of the rear beam 234 and at the center of the lateral direction W. The front beam grip 233a and the rear beam grip 234a are members including grips when the operator holds the process unit 230 attached and detached from the body frame 211 (See FIG. 12), and they are formed in a reverse U-letter shape protruding upwards.

A pair of rear beam guide rollers 234b is supported in a freely rotatable manner at both ends of the rear beam 234. The rear beam guide roller 234b and the side frame guide roller 232c are oriented along the front-to-back direction L. The rear beam guide roller 234b is configured such that it can be operated similarly to the side frame guide roller 232c.

Detailed Configuration of the Photosensitive Unit 250

A photosensitive unit frame 251 is supported by a pair of side frames 232. This photosensitive unit frame 251 includes a first side wall unit 251a, a bottom wall unit 251b, and a second side wall unit 251e. A developing cartridge storage unit 250a that is a space for storing the developing cartridge 240 is formed by the space enclosed by the first side wall unit 251a, the bottom wall unit 251b, and the second side wall unit 251e. Also, between the first side wall unit 251a and the bottom wall unit 251b, a photosensitive drum 252 is supported in a rotatable manner below the developing cartridge storage unit 250a.

With reference to FIGS. 17 and 18, the first side wall unit 251a is fixed with a screw and the like relative to one of the side frames 232 (upper portion in FIG. 17). An alignment collar guide groove 251a1 is formed in the first side wall unit 251a to have an upward opening. The alignment collar storage base end 251a2 at the lower end of the alignment collar guide groove 251a1 is formed almost straight towards the photosensitive drum 252 along the direction indicated by the arrow Z in FIG. 18 (guiding direction). The end of the drum shaft 252a in the photosensitive drum 252 is exposed to the outside of the side frame 232 to be grounded.

The alignment collar guide groove 251a1 is formed as shown in FIG. 19, such that the alignment collar 246 installed at one of the edges of the developing cartridge 240 can be guided along the vertical direction. Also, the alignment collar storage base end 251a2 is formed such that the developing cartridge 240 and the photosensitive unit 250 can be aligned by being brought into contact with the alignment collar 246 as shown in FIG. 19B. That is, if the alignment collar 246 is guided in the alignment collar storage base end 251a2 along the guiding direction and is brought into contact with the lower end of the alignment collar storage base end 251a2, the dimensional relationships between the developing roller driving shaft 244a and the drum shaft 252a are set in a specified state and as a result, the dimensional relationships between the developing roller 244 and the photosensitive drum 252 are set in a specified state.

Again, with reference to FIG. 17 and FIG. 18, a developing cartridge insertion guide roller 257 is supported in freely rotatable manner at the upper end of the bottom wall unit 251b and at the both ends in the lateral direction W. If this developing cartridge insertion guide roller 257 is brought into contact with the guide surface 241m1 (See FIG. 14) in the guide protrusion 241m installed in the developing cartridge 240, the installation of the developing cartridge 240 to the developing cartridge storage unit 250a can be guided along the guiding direction Z as shown in FIG. 18.

With reference to FIG. 17, the second side wall unit 251e is fixed with a screw relative to the other side frame 232 (lower part in FIG. 17). A coupling covering sleeve guide groove 251e1 is formed in the second side wall unit 251e to have an upward opening. This coupling covering sleeve guide groove 251e1 is formed to be able to guide the coupling covering sleeve 248a2 in the coupling unit 248a installed at the other edge of the developing cartridge 240 along the up-and-down direction.

With reference to FIG. 20, a coupling storage base end 251e2 is formed at the lower end of the coupling covering sleeve guide groove 251e1. If the coupling storage base end 251e2 is brought into contact with the coupling covering sleeve 248a2 as shown in FIG. 20B, the developing cartridge 240 and the photosensitive unit 250 can be aligned. That is, when the coupling covering sleeve 248a2 is stored in the coupling storage base end 251e2, the dimensional relationships between the developing roller driving shaft 244a and the drum shaft 252a can be set in a specified state.

A developing roller axial end storage unit 251e3 is formed below the coupling storage base end 251e2. When the coupling covering sleeve 248a2 is stored in the coupling storage base end 251e2, the developing roller axial end storage unit 251e3 can contain the edge of the developing roller driving shaft 244a.

With reference to FIG. 19 and FIG. 20, at least the lower half of the alignment collar guide groove 251a1 is formed at the width narrower than the coupling covering sleeve guide groove 251e1. That is, the alignment collar guide groove 251a1 is formed with a width such that the coupling covering sleeve 248a2 is not stored in the alignment collar storage base end 251a2.

Configuration of Power Supply to Developer Roller

Referring to FIG. 19, a relay electrode part (power supply part) 258 is mounted on the outer surface of the primary side wall 251a. The relay electrode part 258 is made up of a base portion 258a, a fixed portion 258b and an oscillating portion 258c. The relay electrode part 258 is formed as a unit by bending a metal wire.

The base portion 258a is formed into 2-3 rolls of coil. The fixed portion 258b and the oscillating portion 258c are connected to both ends of the base portion 258a. The base portion 258a and the fixed portion 258b are affixed to the corresponding outer side by clinging to the outer side of the primary side wall 251a. The fixed portion 258b is configured and positioned so as to become electrically connected to the prescribed power supply output electrode mounted on the side of the corresponding unit frame 211 when a photosensitive unit 250 is mounted onto the unit frame 211 (see FIG. 12).

The oscillating portion 258c is configured to oscillate elastically around the base portion 258a. The relay electrode part 258 is positioned in such a way that the oscillating portion 258c can protrude into the alignment collar guide groove 251a1. This oscillating portion 258c is configured to form an electrical contact by pressing against the power supply protrusion 247b when a developer cartridge 240 is mounted onto the photosensitive unit 250.

Pressing of Developer Cartridge onto Photosensitive Drum

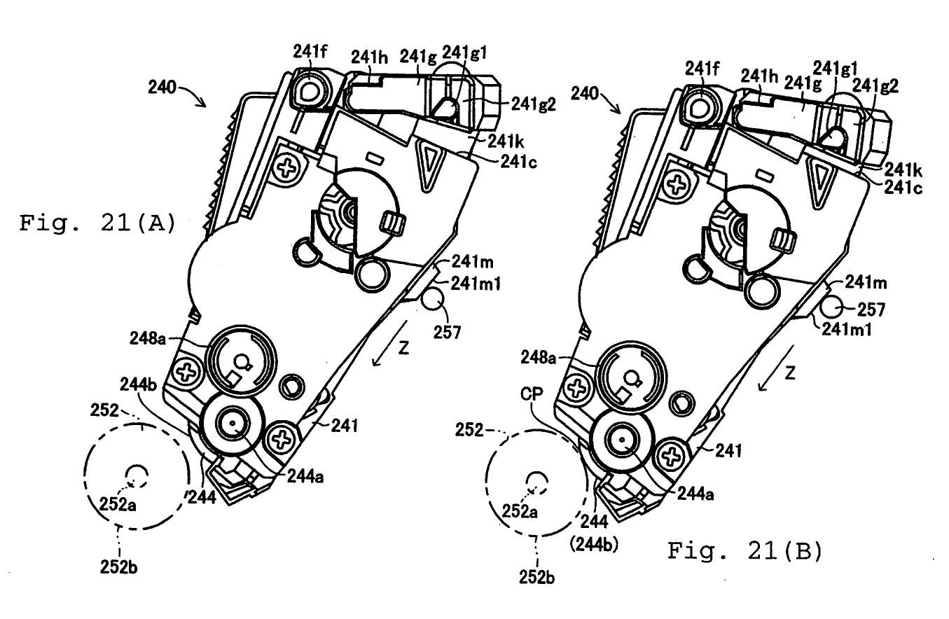

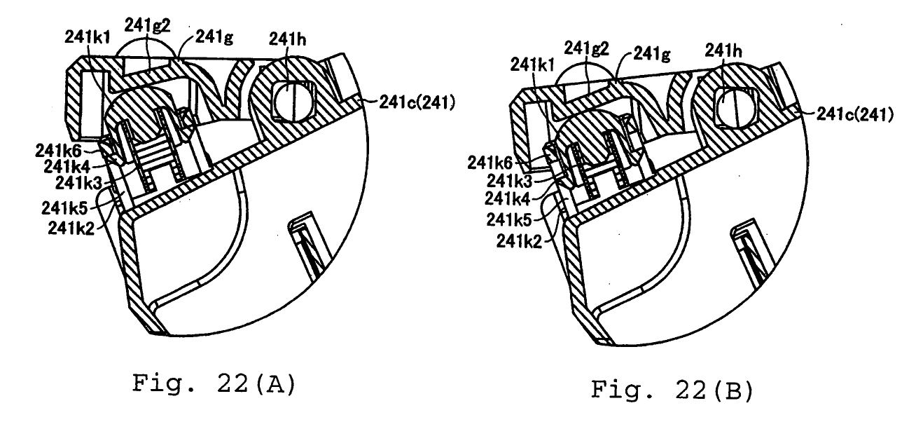

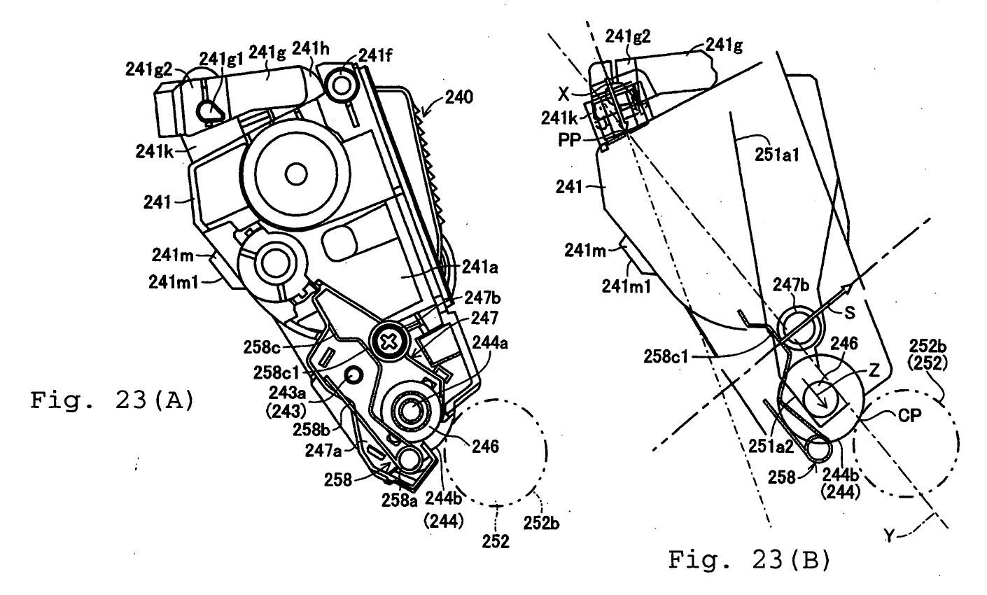

FIGS. 21A and 21B are side views of the developer cartridge 240 shown in FIG. 13. Here, FIG. 21A represents a non-pressed state (wait state), and FIG. 21B represents a pressed state. FIGS. 22A and 22B show enlarged side cross-section views of the vicinity of the urging mechanism 241k as viewed from the developer cartridge 240 shown in FIGS. 21A and 21B, and as viewed from the opposite side. Here, FIG. 22A represents a non-pressed state, and FIG. 22B represents a pressed state. FIG. 23A is a side view of the side opposite the developer cartridge 240 in the pressed state shown in FIG. 21B. FIG. 23B is a schematic diagram explaining the force that acts upon the developer cartridge 240 in a pressed state shown in FIG. 23A.

Referring to FIGS. 21A and 21B, the urging mechanism 241k is configured to elastically impel the developer cartridge case 241 in the guide direction indicated by arrow Z based on the handle 241g being rotated in a clockwise direction around the hinge 241h. In short, the urging mechanism 241k is configured to convert the descent of the pressing member 241g2 due to the downwards pressing of the pressing boss 241g1 mounted on the free end of the handle 241g into force elastically applied along the guide direction Z for the developer cartridge case 241.

Furthermore, the guide protrusion 241m is configured in such a way as to guide the movement of the developer cartridge case 241 along the guide direction Z by having the guide surface 241m1 at the tip touch and rotate the developer cartridge insertion guide roller 257.

Referring to FIGS. 22A and 22B, the urging mechanism 241k is equipped with a moving part 241k1, an urging guide cylinder 241k2 and a developer cartridge spring 241k3.

The moving part 241k1 is housed in the semi-cylindrically shaped urging guide cylinder 241k2. This moving part 241k1 is positioned to move in a roughly updown direction along the central axis of the urging guide cylinder 241k2.

The developer cartridge spring 241k3 is positioned between the moving part 241k1 and the ceiling plate 241c of the developer cartridge case 241. The developer cartridge spring 241k3 is configured to press the moving part 241k1 in a roughly upward direction. In other words, the developer cartridge spring 241k3 is configured to impel the ceiling plate 241c of the developer cartridge case 241 in a roughly downwards direction when the moving part 241k1 is pushed in a roughly downwards direction, as shown in FIG. 22B. In this aspect, the pressing action point for this downwards pressing (impelling) action of the ceiling plate 241c by the developer cartridge spring 241k3 is set to a position that corresponds to the central axis line of the developer cartridge spring 241k3 and the bottom end of the corresponding developing cartridge spring 241k3.

A hook 241k4 is formed on the bottom end of the moving part 241k1 so as to protrude on the side. The hook 241k4 is formed to move in a roughly up-down direction along the inside of the hook movement guide slit 241k5 mounted on the urging guide cylinder 241k2. The top end of the hook movement guide slit 241k5 is blocked by a hook stopper 241k6. In short, the moving part 241k1 is prevented from leaving the urging guide cylinder 241k2 by the hook 241k4 contacting the hook stopper 241k6.

Referring to FIGS. 23A and 23B, the guide protrusion 241m is formed in such a way that the guide surface 241m1 at the tip has a surface that is parallel to the pressing action line Y, that is the straight line that joins the pressing action point, i.e., pressing position PP, to the contact position (developer position) CP. In short, the corresponding pressing action line Y is set to be parallel to the base of the alignment collar housing 251a2 (guide direction Z).

Furthermore, in the present embodiment, the guide surface 241m1 for the guide protrusion 241m is configured so that it is pressed towards the developer guide cartridge insertion guide roller 257 (see FIG. 21) at a prescribed strength by making the angle formed by the developer cartridge pressing direction X at the pressing position PP and the pressing action line Y to roughly 20 degrees.

Furthermore, in the present embodiment, a power supply counterpart 258c1 having a straight shape is formed at a position opposite the power supply protrusion 247b at the oscillation portion 258c of the relay electrode part 258. Also, the relay electrode part 258 is configured so that the power supply counterpart 258c1 is parallel to the pressing action line Y and guide direction Z when the developer cartridge 240 is in the pressed status (when the toner bearing surface 244b on the developer roller 244 is in contact at the prescribed pressure with the image bearing surface 252b on the photosensitive drum 252).

Moreover, in the present embodiment, the relay electrode part 258 is configured so that the power supply counterpart 258c1 for the oscillating area 258c of the relay electrode part 258 presses against the power supply protrusion 247b of the conductive part 247 in a direction that is partially orthogonal to the pressing action line Y and the guide direction Z. In short, the relay electrode part 258 is configured in such a way that the power supply pressing direction S, i.e., the direction in which the power supply protrusion 247b is pressed by the power supply counterpart 258c1, is partially orthogonal to the pressing action line Y and the guide direction Z. Concretely, the angle for each is set to roughly 90 degrees (no less than 89.0 degrees, no greater than 91.0 degrees).

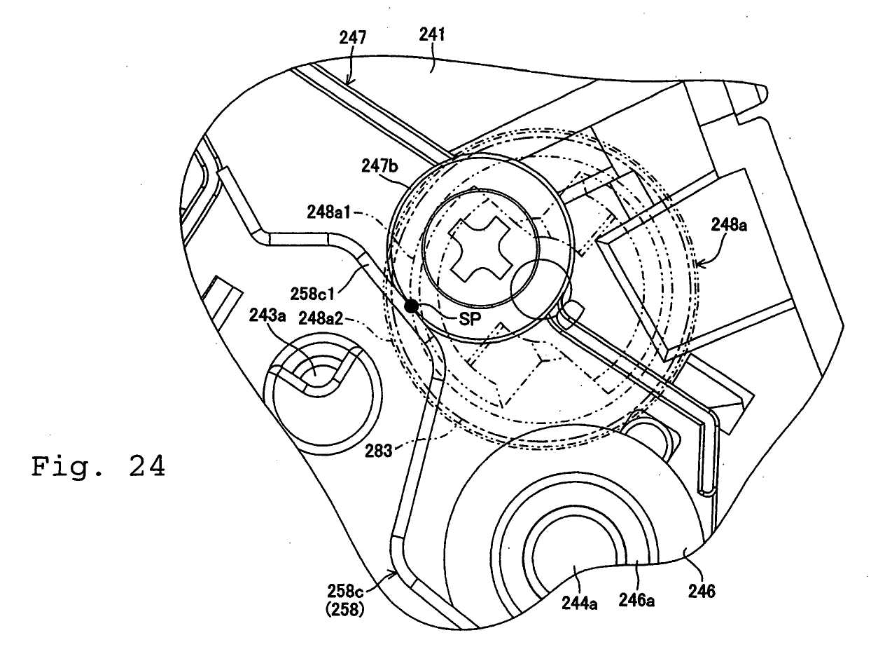

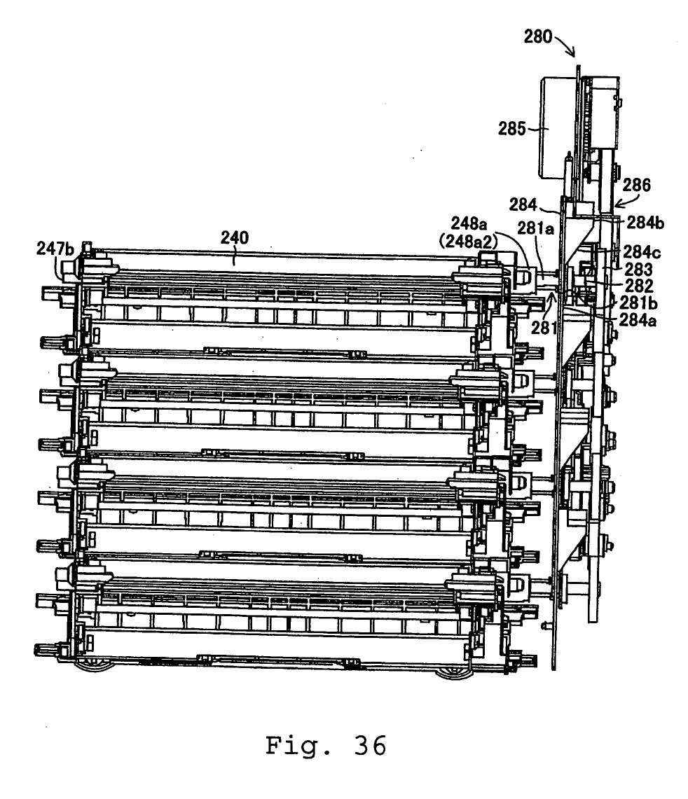

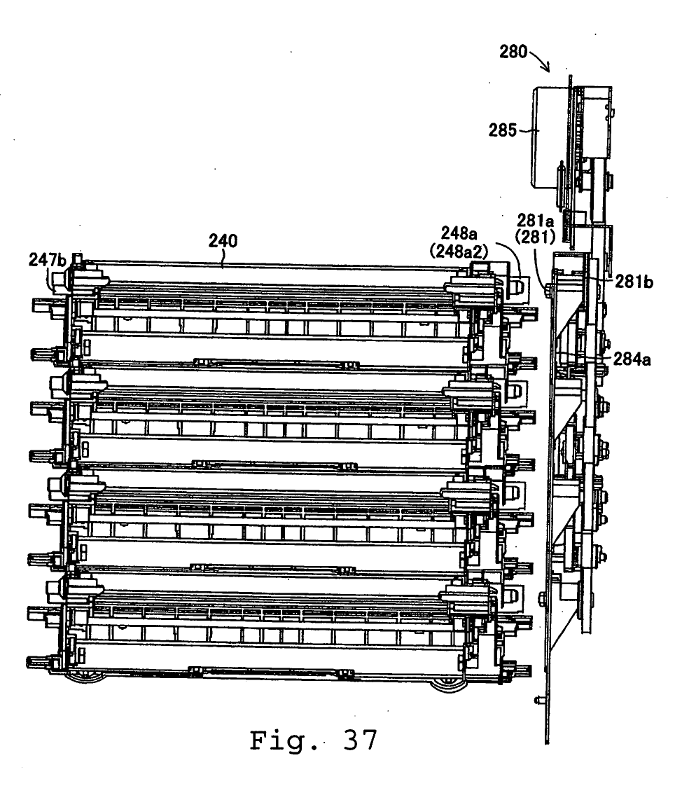

Here, FIG. 24 is a magnified side view of the area around the conductive part 247b indicated in FIG. 23. Note that, in FIG. 24, a dotted line with two dots is used to indicate the side where the corresponding conductive part 247 is mounted and the opposite side where the coupling 248a is mounted on the developer cartridge case 241, and where the coupling drive gear 283 is mounted on the same axis as the corresponding coupling 248a. The area surrounding this coupling gear 283 is described concretely elsewhere (making reference to FIG. 36 and FIG. 37).

Referring to FIG. 24, the outer diameter of the coupling joint 248a1 of the coupling 248a is formed to be larger than the outer diameter of the micro diameter 246a housed within the alignment collar housing base 251a2 (alignment collar storage base end) of the color part (alignment collar) 246 (see FIGS. 23A and 23B) and the power supply protrusion 247b of the conductive part 247. Also, the outer diameter of the coupling joint 248a1 and the coupling drive gear 283 are formed to have a shape that encapsulates the power supply pressing position SP when seen laterally along the width direction. The power supply pressing position SP is the position at which the power supply protrusion 247b and power supply counterpart 258c1 on the oscillating portion 258c of the relay electrode part 258 are in contact.

Configuration for Selective Pressing of Several Developer Cartridges

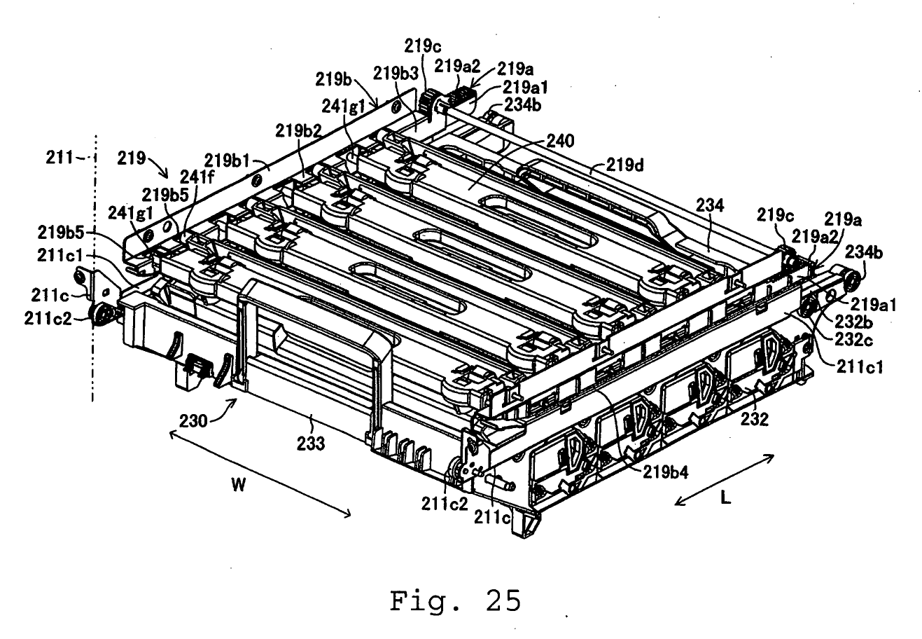

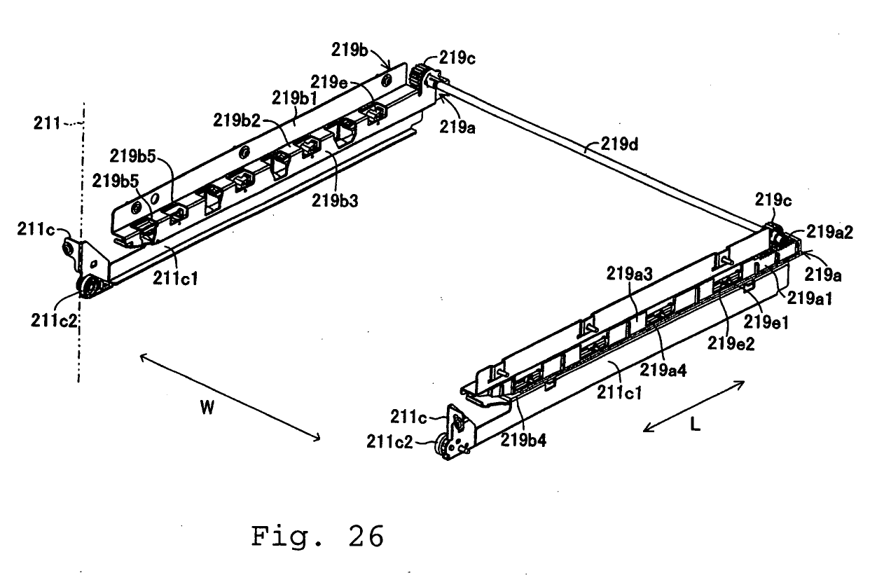

FIG. 25 is a magnified perspective view of the area around the process unit 240 shown in FIG. 12. FIG. 26 is a magnified perspective view of the area surrounding the slide guide frame 211c and the linear cam mechanism 219 shown in FIG. 12. In short, FIG. 26 is the same as FIG. 25 minus the process unit 230.

Referring to FIG. 25, the slide guide frame 211c is configured to support both ends of the process unit 230 in the width direction W, as well as the upper end in the height direction. The slide guide frame 211c is equipped with a slide rail 211c1 and a slide guide roller 211c2.

The slide rail 211c1 is configured to act as a counterpart when brought close to upper end of the side frame 232 (guide rib 232b in FIG. 17) while the process unit 230 is housed within the unit frame 211. In addition, the slide rail 211c1 and the slide guide roller 211c2 are configured to guide movement along the front-back back direction L for the corresponding process unit 230 by working with the side frame 232 (side frame guide roller 232c and guide rib 232b in FIG. 17) and the rear beam guide roller 234b of the process unit 230.

The linear cam mechanism 219 is equipped with a cylindrical cam part 219a, a cam support frame 219b, a pinion gear 219c and a gear axis 219d.

The cylindrical cam part 219a is formed to have a front-rear direction L and a parallel longitudinal direction, and configured and positioned to perform reciprocal motion along the corresponding front-rear direction L. In short, a rack gear 219a2 is formed on the top of the cam base 219a1, i.e., the tip of the rear side (top right in the figure) of the cylindrical cam part 219a. The rack gear 219a2 is configured to mesh with the pinion gear 219c.

One pair of pinion gear 219c is connected by a gear axis 219d so that they do not rotate relative to each other. In addition, one pair of pinion gear 219c and the gear axis 219d are configured to enable reciprocal motion along the front-rear direction L while synchronizing so that it is in phase (position in front-rear direction L) with the other cylindrical cam part 219a in the event that the other cylindrical cam part 219a is moved along the front-rear direction L by a drive mounted on the unit frame 211 not shown on the diagram.

(Note that, for the purpose of facilitating the explanation of the fact that the cylindrical cam part 219a can move along the front-rear direction, the cylindrical cam part 219 on the left side of the diagram is shown in the rear-most position, and the cylindrical cam part 219a on the right side of the diagram is shown in the middle position. However, the linear cam mechanism 219 can be configured so that the movement of both the cam parts is synchronized. Therefore, in reality this situation will never occur.)

The cam support frame 219b is composed of a cam support frame base 219b1, a cam support frame upper plate 219b2, a cam support frame side plate 219b3 and a cam support frame floor plate 219b4. The cam support frame 219b is formed as a unit using a metal plate.

The cam support frame base 219b1 is mounted on the cam support frame upper plate vertically from the outer edge in the width direction W. By fixing the cam support frame base 219b1 into place on the interior wall of the unit frame 211 using a screw or the like, the corresponding cam support frame 219b is supported on the interior of the unit frame 211.

The cam support frame side plate 219b3 is mounted vertically from the interior edge of the cam support frame upper plate 219b2 in the width direction W. In addition, a cam support frame floor plate 219b4 is mounted so that it protrudes towards the exterior in the width direction W from the lower edge of the cam support frame side plate 219b3. Finally, the cylindrical cam part 219a is housed on the space surrounded by the cam support frame upper plate 219b2, the cam support frame side plate 219b3 and the cam support frame floor plate 219b4.

A boss housing opening 219b5 is formed to straddle the cam support frame upper plate 219b2 and the cam support frame side plate 219b3. The boss housing opening 219b5 is configured to face the separator boss 241f, the pressing boss 241g1 and the cylindrical cam part 219a on the developer cartridge 240 when the process unit 230 is housed in the unit frame 211.

FIG. 27 is a perspective view of the pair of cylindrical cam parts 219a shown in FIG. 26. Referring to FIG. 26 and FIG. 27, there are several (four) auxiliary cam parts 219e for each cylindrical cam part 219a.

Referring to FIG. 26, the auxiliary cam part 219e is positioned to meet the boss housing opening 219b5. The auxiliary cam part 219e is configured to rotate freely around the auxiliary cam rotation pin 219e, which is parallel to the width direction W. The interior edge of the auxiliary cam rotation pin 219e1 in the width direction W is supported by a perforated hole formed directly beneath the boss housing opening 219b5 on the cam support frame side plate 219b3. In short, the auxiliary cam part 219e is supported so that it can move along the front-rear direction L by way of the perforated hole formed on the cam support frame side plate 219b3.

Referring to FIG. 27, to facilitate the explanation, a ‘symbol has been added to the auxiliary cam part 219e that is furthest to the front in the diagram (bottom right in FIG. 27). Nevertheless, apart from instances where this auxiliary cam part 219e’ moves in a timing that differs from other auxiliary cam parts 219e accompanying movement of the cylindrical cam part 219a along the front-rear direction L, this auxiliary cam part 219e′ is configured identically to the other auxiliary cam parts 219e. Similarly, a ‘sign has been added to the elements of the cylindrical cam part 219a farthest to the front in order to establish a correspondence with the auxiliary cam part 219e’.

Several (four) slot-shaped auxiliary cam guide holes 219a4 having a longitudinal direction parallel to the front-rear direction L are formed on the thin auxiliary cam guide wall 219a3, which makes up the outer wall of the cylindrical cam part 219a in the width direction W. The auxiliary cam guide holes 219a4 are formed into the same shape, and positioned in such a way that they will be arranged in line in the front-rear direction. In addition, the auxiliary cam part 219e is equipped with an auxiliary cam rotation protrusion 219e2 that protrudes towards the outside of the auxiliary cam part 219e in the width direction W. The auxiliary cam rotation protrusion 219e2 is inserted into the auxiliary cam guide hole 219a4.

In short, the auxiliary cam part 219e is supported in such a way that it can rotate by the hole formed on the cam support frame side wall 219b3 (see FIG. 26), and by the auxiliary cam guide hole 219a4. Furthermore, the auxiliary cam part 219e is supported in such a way that it can move relative to the corresponding cylindrical cam part 219a and the longitudinal direction of the auxiliary cam guide hole 219a4 accompanying reciprocal motion of the cylindrical cam part 219a along the front-rear direction L. Here, as shown in FIG. 26 and FIG. 27, the corresponding auxiliary cam guide hole 219a4 is formed in such a way that the position in the front-rear direction of the auxiliary cam rotation protrusion 219e2 in the auxiliary cam guide hole 219a4 will be the same for all four auxiliary cam guide holes 219a4. In short, the four auxiliary cam guide holes 219a4 and corresponding auxiliary cam guide parts 219e are all positioned so that they match one another.

Referring to FIG. 27, an auxiliary cam support 219a5 is formed so that it protrudes towards the interior in the width direction W from the bottom edge of the auxiliary cam guide wall 219a3 that forms the outer wall of the cylindrical cam part 219a. The auxiliary cam support 219a5 is configured so that it can support the auxiliary cam part 219e from the bottom. The auxiliary cam support 219a5 is formed in a position corresponding to the auxiliary cam guide hole 219a4.

An auxiliary cam contact wall 219a6 is formed to stand upwards from the front (bottom left in FIG. 27) edge of the auxiliary cam support 219a5. The auxiliary cam contact wall 219a6 is configured in such a way that it will be able to contact the auxiliary cam part 219e when the cylindrical cam part 219a moves to the rear (upper right in FIG. 27). The position of these four pairs of auxiliary cam contact walls 219a6 and auxiliary cam parts 219e (auxiliary cam rotation protrusion 219e2) relative to one another is also made to match.

An auxiliary cam exposed opening 219a7 that opens downwards is formed even further behind the edge of the rear (upper right in FIG. 27) of the auxiliary cam support 219a5. In addition, a pressing boss depress area 219a8 is formed so that it extends towards the front from the upper edge of the auxiliary cam contact wall 219a6. This pressing boss depress area 219a8 will be described in detail below, but it is configured so that it can depress the corresponding pressing boss 241g1 by joining the pressing boss 241g1 (see FIG. 25) when the cylindrical cam part 219a moves to the front.

Here, the length along the front-rear direction L of the auxiliary cam support 219a5 is set to be shorter than the auxiliary cam guide hole 219a4. In short, the tip on the rear of the auxiliary cam guide hole 219a4 is formed upwards from the auxiliary cam exposed opening 219a7. Moreover, the auxiliary cam support 219a5′ closest to the front is formed shorter than the other auxiliary cam supports 219a5. On the other hand, the pressing boss depressed area 219a8′ closest to the front is formed longer than the other pressing boss depressed areas 219a8.

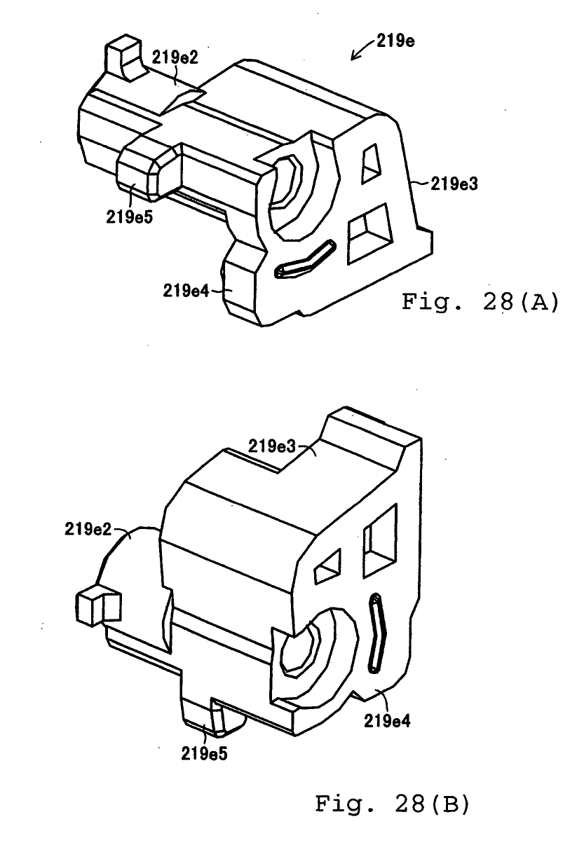

FIG. 28 is a magnified perspective view of the auxiliary cam part 219e shown in FIG. 27. Here, FIG. 28A illustrates the auxiliary cam part 219e fallen (fallen state), and FIG. 28B illustrates the auxiliary cam part 219e standing (standing state). In short, by rotating around the auxiliary cam rotation protrusion 219e2, the auxiliary cam part 219e can be set to either of two states: the fallen state as shown in FIG. 28A, or the corresponding standing state shown in FIG. 28B.

Referring to FIGS. 28A and 28B, a separator boss mount 219e3 having a mild slant is formed on the top edge (tip) of the auxiliary cam part 219e in the standing state shown in FIG. 28B. A protrusion is formed on the rear edge (top right edge in FIG. 28B) of the separator boss mount 219e3. On the other hand, the front tip of the separator boss mount 219e3 is formed to have a smooth slope or a beveled shape so that, when it comes into contact with the separator boss 241f (see FIG. 25), the corresponding separator boss 241f can easily ride onto the separator boss mount 219e3.

A first downward protrusion of the auxiliary cam 219e4 and a second downward protrusion of the auxiliary cam 219e5 are formed extending downwards on the lower edge of the auxiliary cam part 219e in standing state shown in FIG. 28B. The first downward protrusion of the auxiliary cam 219e4 and second downward protrusion of the auxiliary cam 219e5 are positioned so that they will occupy a different position relative to the width direction, i.e., the direction of the rotation axis (the direction of the central axis of the auxiliary cam rotation protrusion 219e2). Concretely, the first downward protrusion of the auxiliary cam 219e4 is mounted closer to the interior in the width direction (#down right in FIGS. 28A and 28B; interior in the width direction W in FIG. 27) than the second downward protrusion of the auxiliary cam 219e5.

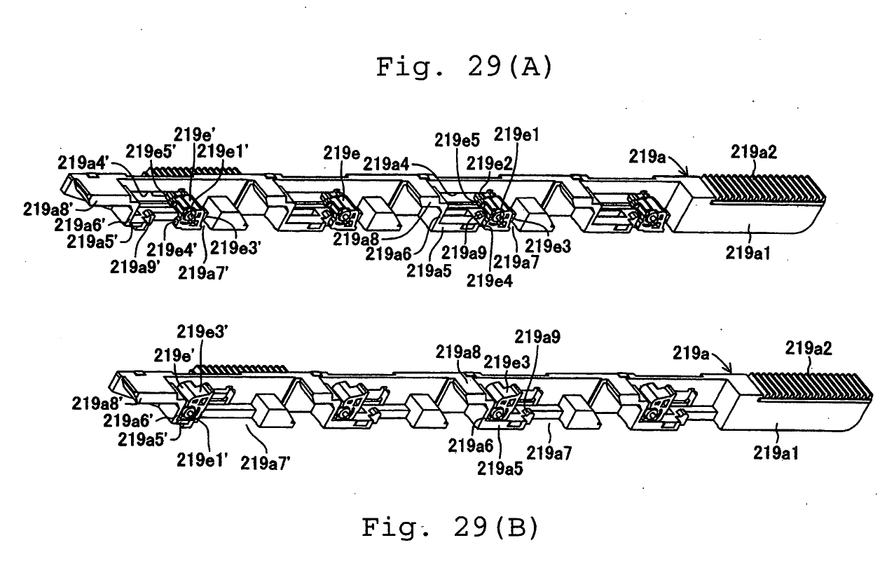

FIGS. 29A and 29B is a magnified perspective view of the cylindrical cam part 219a and auxiliary cam part 219e shown in FIG. 27. Here, FIG. 29A illustrates the cylindrical cam part 219a in its foremost position, and FIG. 29B illustrates the cylindrical cam part 219a in its rearmost position. (As stated previously, the position of the auxiliary cam part 219e (auxiliary cam rotation pin 219e1) in the front-rear direction is fixed, irrespective of the movement of the cylindrical cam part 219a.)

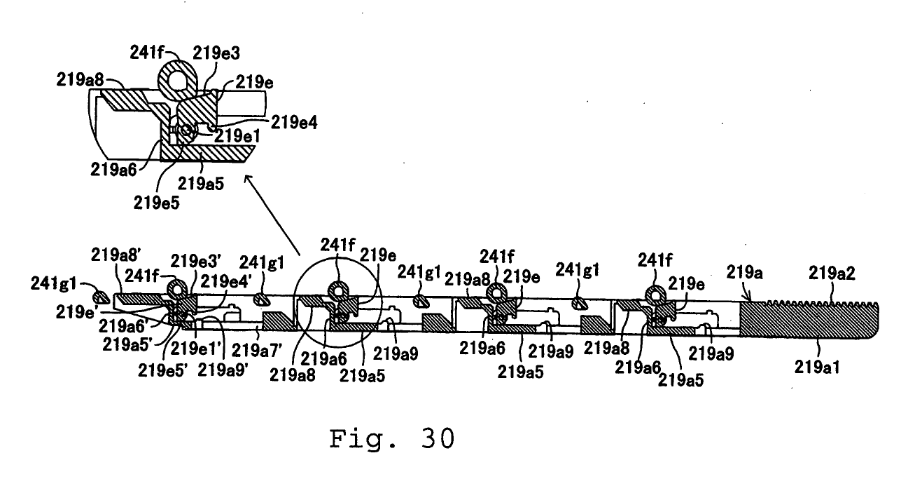

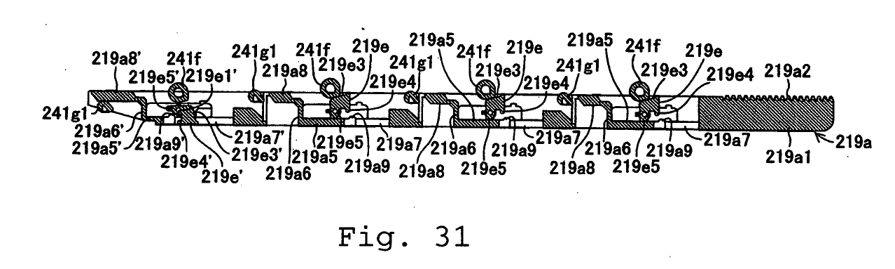

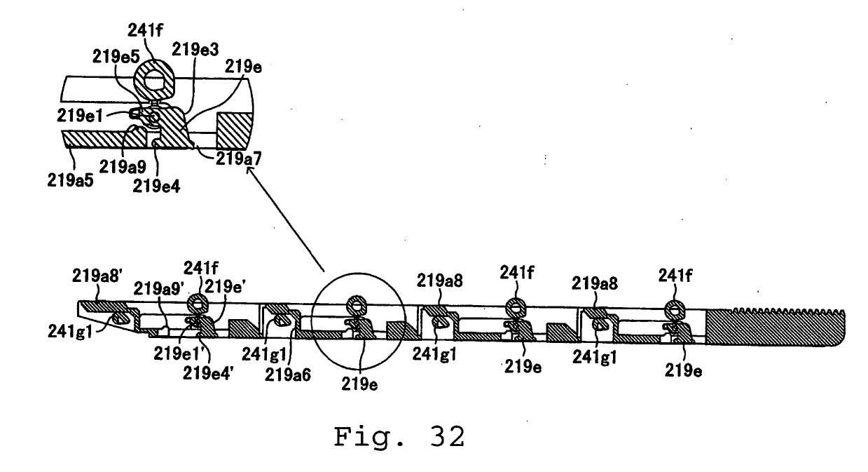

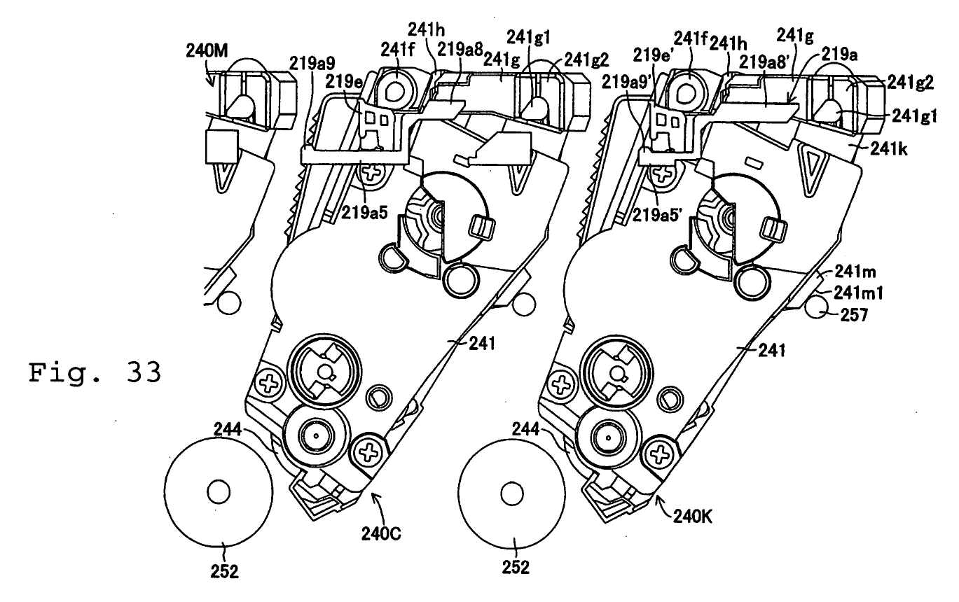

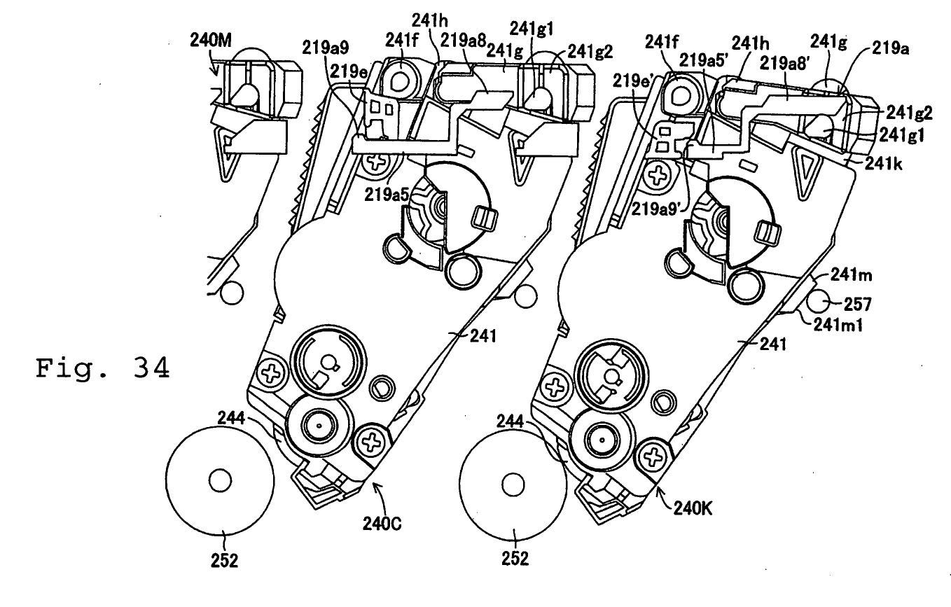

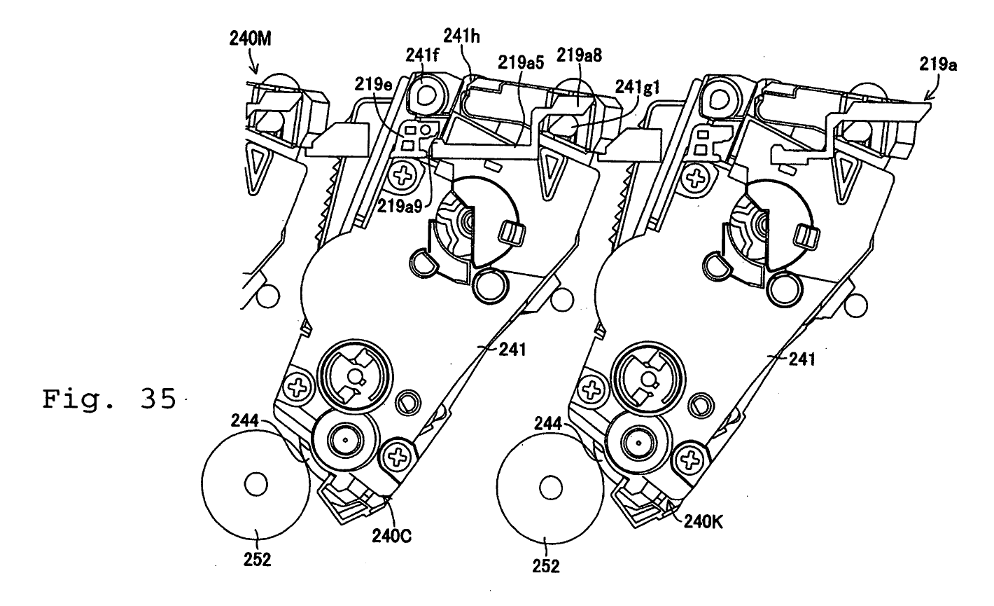

FIG. 30 through FIG. 32 are lateral cross-sections of the cylindrical cam part 219a and the auxiliary cam part 219e shown in FIGS. 29A and 29B. Here, FIG. 30 illustrates the cylindrical cam part 219a in its rearmost position (right side in diagram), FIG. 32 illustrates the cylindrical cam part 219a in its foremost position (left side in diagram), and FIG. 31 illustrates the intermediary position. Furthermore, FIG. 33 through FIG. 35 are magnified side views of the developer cartridge 240 and the linear cam mechanism 219 shown in FIG. 25. Note that the front-rear direction is reversed in FIGS. 30 through 32 and FIGS. 33 through 35. In short, FIGS. 30 through 32 are cross-sections of the cylindrical cam part 219a etc. seen from the side and the opposite side of the developer cartridge case 241 shown in FIGS. 33 through 35. FIG. 30 corresponds to FIG. 33; FIG. 31 corresponds to FIG. 34; and FIG. 32 corresponds to FIG. 35.

Referring to FIGS. 29A and 29B, the rear edge (right side in diagram) of the auxiliary cam support 219a5 is configured in such a way that it contacts the first downward protrusion of the auxiliary cam 219e4 on the auxiliary cam part 219e.

Furthermore, an auxiliary cam rotation protrusion 219a9 is formed further to the rear than the rear edge of the auxiliary cam support 219a5 and further on the outside of the auxiliary cam part 219e in the width direction. The auxiliary cam rotation protrusion 219a9 is mounted in such a way that it protrudes upwards from the position in the width direction that corresponds (is able to contact) the second downward protrusion of the auxiliary cam 219e5 on the auxiliary cam part 219e.

Referring to FIG. 29 through FIG. 32, the cylindrical cam part 219a and auxiliary cam part 219e are configured in such a way that the auxiliary cam part 219e will rotate clockwise in the diagram to fallen state when the cylindrical cam part 219a moves to the front side (left side in the diagram) (when the auxiliary cam part 219e moves to the rear relative to the cylindrical cam part 219a). In short, an auxiliary cam rotation protrusion 219a9 is formed in such a way as to make it possible to rotate the auxiliary cam part 219e through contact with the second downward protrusion of the auxiliary cam 219e5 upon movement of the cylindrical cal cam part 219a to the front. (This concept is easier to understand if the figures are viewed in this order: FIG. 30, FIG. 31, and FIG. 32.) The auxiliary cam part 219e in fallen state is positioned on the top of the auxiliary cam exposed opening 219a7.

Here, the foremost auxiliary cam rotation protrusion 219a9′ is formed at roughly the center in the front-rear direction of the foremost auxiliary cam guide hole 219a4′. On the other hand, the other auxiliary cam rotation protrusion 219a9 is formed close to the edge of the rear of the other auxiliary cam guide hole 219a4. In short, the relative position of the foremost auxiliary cam rotation protrusion 219a9′ to the other auxiliary cam rotation protrusion 219a9 is set in such a way that the movement of the cylindrical cam part 219a to the front causes the fore-most auxiliary cam part 219e′ to enter fallen state prior to the other auxiliary cam part 219e.

Furthermore, as stated above, the pressing boss depress area 219a8 is configured in such a way that when the cylindrical cam part 219a moves to the front, it rises onto the pressing boss 241g1, pressing the corresponding pressing boss 241g1 downwards. In short, a slanted surface is formed on the end of the foremost side of the pressing boss depress area 219a8 in such a way as to facilitate rising onto the corresponding pressing boss 241g1 when contact is made with the pressing boss 241g1. Here, the foremost pressing boss depress area 219a8′ is formed longer than the other pressing boss depress area 219a8 in order to make it possible to press the pressing boss 241g1 located at the foremost position to be pressed prior to the other pressing boss 241g1.

On the other hand, the cylindrical cam part 219a and the auxiliary cam part 219e are configured in such a way that the auxiliary cam part 219e will rotate counterclockwise in the figures to standing state when the cylindrical cam part 219a moves to the rear (right side in the figure) (when the auxiliary cam part 219e moves forward relative to the cylindrical cam part 219a). In short, the first downward protrusion of the auxiliary cam 219e4 is formed and positioned in such a way as to make it possible for the auxiliary cam part 219e to be rotated by contact with the rear end of the auxiliary cam support 219a5 upon movement of the cylindrical cam part 219a to the rear. (This concept is easier to understand if the figures are viewed in this order: FIG. 32, FIG. 31, and FIG. 30.) The auxiliary cam part 219e in standing state is supported by the top part of the auxiliary cam support 219a5.

Here, as stated above, the foremost auxiliary cam support 219a5′ is formed shorter than the other auxiliary cam support 219a5. In short, the dimensions of the foremost auxiliary cam support 219a5′ and the other auxiliary cam support 219a5 are set in such a way that the foremost auxiliary cam part 219e′ reaches a standing state prior to the other auxiliary cam part 219e upon the movement to the rear of the cylindrical cam part 219a.

Furthermore, as shown in FIG. 33 through FIG. 35, the cylindrical cam part 219a is configured in such a way as to impel the black developer cartridge 240K, the cyan developer cartridge 240C and the magenta developer cartridge 240M arranged in the front-rear direction towards the photosensitive drum 252 positioned beneath each by pushing the pressing boss 241g1 downwards in response to the state of movement in the front-rear direction. Moreover, the auxiliary cam part 219e is configured in such a way as to be able to retain the black developer cartridge 240K, etc., in a prescribed retreated status upwards from the developer roller 244 and the photosensitive drum 252 by pushing the separator boss 241f when the standing state is entered in response to movement in the front-rear direction of the cylindrical cam part 219a.

Furthermore, the cylindrical cam part 219a and the auxiliary cam part 219e (auxiliary cam part 219e′) are configured in such a way as to be able to push only the black developer cartridge 240K towards the photosensitive drum 252 while retaining the cyan developer cartridge 240C, etc., in the retreated status in response to movement in the front-rear direction of the corresponding cylindrical cam part 219a.

Structure for Delivering Rotational Driving Power

FIG. 36 and FIG. 37 are views from below of the developer cartridge 240 mounted on the unit frame 211 shown in FIG. 12, and of the driving power delivery mechanism for delivering rotational driving power to this developer cartridge 240. Referring to FIG. 36 and FIG. 37, the rotational driving power delivery mechanism 280 is made up of a drive rotation unit 281, a drive rotation unit spring 282, a coupling drive gear 283, a drive rotation unit movement cam 284, a motor 285 and a gear array 286.

The four drive rotation units 281 are arranged along the front-rear direction (the up-down direction in the diagram) to align them with the coupling 248a on the four developer cartridges 240. The drive rotation units 281 are equipped with a coupling joint axis 281a and a flange 281b.

The coupling joint axis 281a is configured in such a way as to be able to combine with the corresponding coupling 248a when the tip is inserted into the coupling 248a. The coupling joint axis 281a and the coupling 248a are configured in such a way as to be able to deliver rotational drive power from the rotational drive power delivery mechanism 280 to the developer cartridges 240. The flange 281b is formed at the base (the right edge in the figure) of the coupling joint axis 281a.

The drive rotation unit spring 282 is positioned in such a way that one end contacts the flange 281b and the other end contacts the coupling drive gear 283. The drive rotation unit spring 282 is configured in such a way as to push the flange 281b (drive rotation unit 281) towards the coupling 248a.

The coupling drive gear 283 is configured in such a way as to be able to rotate together with the drive rotation unit 281. In short, by joining the central rotation axis of the coupling drive gear 283 to the joint hole formed inside the central rotation axis of the drive rotation unit 281 (coupling joint axis 281a), the drive rotation unit 281 and the coupling drive gear 283 are configured such that both will not be able to rotate in the same direction relative to one another.

Moreover, drive rotation unit 281 and coupling drive gear 283 are configured in such a way as to be able to move relative to one another in the axis direction. In short, the drive rotation unit 281 and the coupling drive gear 283 are configured in such a way as to enable the central rotation axis of the coupling drive gear 283 to slide in the axis direction inside the joint hole formed inside the central rotation axis of the drive rotation unit 281 (coupling joint axis 281a).

The drive rotation unit movement cam 284 is configured in such a way as to enable the setting of the position in the axis direction (width direction) of the four drive rotation units 281 arranged in the front-rear direction. Concretely, four pairs of cam floor surface 284a, cam peak surface 284b and cam slant surface 284c are formed on the drive rotation unit movement cam 284.

As shown in FIG. 36, the cam floor surface 284a is formed in such a way that it can touch the flange 281b of the drive rotation unit 281 positioned to join the coupling 248a. Moreover, as shown in FIG. 37, the cam peak surface 284b is formed in such a way that it can touch the flange 281b of the drive rotation unit 281 positioned away from the coupling 248a. The cam slant surface 284c is formed in such a way as to allow the cam floor surface 284a to connect smoothly with the cam peak surface 284b.

In short, the drive rotation unit movement cam 284 is configured in such a way that it can move the flange 281b slowly towards the outside (right side in FIG. 36) in the width direction on the cam slanted surface 284c in response to the pressing force of the drive rotation unit spring 282 when it is moved from the position shown in FIG. 36 to a position located downwards by a solenoid or other cam mechanism, etc., not shown. The drive rotation unit movement cam 284 is also configured in such a way as to be able to move the drive rotation unit 281 to the retreat position shown in FIG. 37. Furthermore, the drive rotation unit movement cam 284 is configured in such a way as to be able, when moved to a position upwards in the from the position shown in FIG. 37 by a solenoid or the like not shown, to move the drive rotation unit 281 to the joint position shown in FIG. 36 by the pressing force of the drive rotation unit spring 282.

The gear array 286 is configured in such a way as to be able to deliver rotational drive power produced by the motor 285 to the four coupling drive gears 283.

Explanation of Operation Using According to Aspects

Next, we will make reference to diagrams to explain the operation when a process unit 240 is mounted onto/removed from the body 210 of a color laser printer 200 in aspects shown in FIG. 12.

Mounting/removing a Developer Cartridge

Referring to FIG. 16 and FIG. 17, when a user is mounting or removing a developer cartridge 240 onto the process unit frame 230a of the process unit 230, the user grips the center in the width direction of the handle 241g mounted on the top end of the developer cartridge 240. Consequent to this, the handle 241g enters the standing state shown in FIG. 16. Next, when the user pulls the standing handle 241g upwards, the developer cartridge 240 moves roughly upwards, guided by the alignment collar guide groove 251a1 and the coupling shield sleeve guide groove 251e1 formed on both ends in the width direction of the photosensitive unit frame 251. The developer cartridge 240 is mounted onto or removed from the photosensitive unit 250 in this way.

Mounting of the developer cartridge 240 onto the process unite frame 240a, on the other hand, is performed with the handle 241 down, as shown in FIGS. 19A and 19B and FIGS. 20A and 20B. In this case, the developer cartridge 240 the top, i.e., the center in the width direction, is grasped. The alignment collar 246 is inserted into the alignment collar guide groove 251a1, as shown in FIG. 19A. Furthermore, the coupling shield sleeve 248a2 is inserted into the coupling shield sleeve guide groove 251e1, as shown in FIG. 20A.

If the developer cartridge 240 is pressed further downwards in this state, the alignment collar 246 will be housed inside the alignment collar housing base 251a2, as shown in FIG. 19B. Moreover, the coupling shield sleeve 248a2 will be housed in the coupling housing base 251e2, as shown in FIG. 20B. Furthermore, the end of the developer roller rotation drive axis 244a, which does not have an alignment collar 246, will be housed in the developer roller axis end housing 25 1e3.

Here, referring to FIG. 18 and FIGS. 19A and 19b, the sliding part 258c of the relay electrode part 258 protrudes into the alignment collar guide groove 251a1. Consequently, the sliding part 258c contacts the alignment collar 246. As a result of this, the sliding part 258c is pushed downwards by the alignment collar 246, sliding temporarily to the left (rotating counterclockwise in the figures). After this, the sliding part 258c contacts the power supply protrusion 247b.

In this way, the sliding part 258c protrudes inside the alignment collar guide groove 251a1 when a developer cartridge 240 is mounted, touching the power supply protrusion 247b after being pushed and slid by the alignment collar 246. Consequently, this makes it possible to smoothly form an electrical connection by contact between the power supply protrusion 247b and the relay electrode part 258 when mounting a developer cartridge 240.

Furthermore, referring to FIG. 18 and FIGS. 19A and 19B, the lower half of the alignment collar guide groove 251a1 is formed thinner than the coupling shield sleeve guide groove 251e1. Consequently, if an attempt is made to insert the coupling shield sleeve 248a2 into the alignment collar guide groove 251a1 with the developer cartridge 240 in the wrong position, the corresponding coupling shield sleeve 248a2 will be prevented from entering by the top of the alignment collar guide groove 251a1. This makes it possible to ensure that the developer cartridge 240 is not mounted incorrectly onto the photosensitive unit 250.

Force/pressure of Developer Cartridge Towards Photosensitive drum

Referring to FIGS. 21A and 21B, when the state of the developer cartridge 240 changes from the retreat status shown in FIG. 21A to the pressed status shown in FIG. 21B (ready to draw), the pressing boss 241g1 is depressed. Consequently, the handle 241g rotates slightly clockwise around the hinge 241h. As a result, the pressing member 241g2 of the free end of the handle 241g moves downward. This produces a force that elastically pushes the developer cartridge case 241 along the guide direction Z by the urging mechanism 241k mounted below the pressing member 241g2.

In short, referring to FIGS. 22A and 22B, the moving part 241k mounted on the urging mechanism 241k is depressed by the downward motion of the pressing member 241g2. As a result, as shown in FIG. 22B, the developer cartridge spring 241k3 becomes more contracted than shown in FIG. 22A. When the developer cartridge spring 241k3 is contracted in this manner, energy is produced in the developer cartridge spring 241k3. The energy impels the ceiling plate 241c of the developer cartridge case 241 downward.

Referring again to FIGS. 21A and 21B, when the ceiling plate 241c of the developer cartridge case 241 is impelled downward in this manner, the developer cartridge 240 moves from the retreat position shown in FIG. 21A to the pressed position shown in FIG. 21B. In short, the developer cartridge 240 moves toward the photosensitive drum 252. The direction of this movement, referring to FIGS. 23A and 23B, is the direction in which the alignment collar 246 moves within the alignment collar housing base 251a2 (guide direction Z).

Here, referring to FIG. 23B, the pressing action line Y, which is a straight line connecting the pressing position PP pressing action point by the urging mechanism 241k with the contact point (development position) CP, is parallel with the guide direction. Consequently, the force produced by the urging mechanism 241k enables smooth movement of the developer cartridge 240.

Furthermore, the angle formed by the developer cartridge pressing direction X for the pressed position PP with the pressing action line Y is approximately 20 degrees.

As a result of this, most of the force applied to the corresponding pressed position PP is transmitted to the contact position CP without major loss. Consequently, the prescribed contact state between the toner bearing surface 244b on the developer roller 244 and the image bearing surface 252b on the photosensitive drum 252 can be reproduced stably. Furthermore, the guide surface 241m on the guide protrusion 241m is parallel to the guide direction Z. Consequently, referring to FIGS. 21A and 21B, the guide surface 241m1 of the guide protrusion 241m will be pressed appropriately towards the developer cartridge insertion guide roller 257. As a result, the movement of the developer cartridge 240 along the guide direction Z will be guided smoothly by the corresponding developer cartridge insertion guide roller 257.

Moreover, during the movement of the developer cartridge 240 along the guide direction Z from the retired position shown in FIG. 21A to the pressed position shown in FIG. 21B, the power supply protrusion 247b and the power supply counterpart 258c1 formed parallel to the pressing action line Y and guide direction Z will slide. Consequently, from the point in time at which the developer roller 244 is at the retired position, developer bias voltage can be applied between the developer roller 244 and photoelectric drum 252 via the relay electrode part 258 and power supply protrusion 247b.

Moreover, as shown in FIG. 23B, the power supply pressing direction S in which the power supply protrusion 247b is pressed by the power supply counterpart 258c1 at the contact point between the power supply protrusion 247b and the power supply counterpart 258c1 is partially orthogonal with the pressing action line Y and guide direction Z. As a result, almost no elements are generated parallel to the guide direction Z in the power supply pressing force from the relay electrode part 258 (power supply counterpart 258c1). Consequently, the prescribed contact state between the toner bearing surface 244b on the developer roller 244 and the image bearing surface 252b on the photosensitive drum 252 is stabilized.

Furthermore, the power supply counterpart 258c1 and the power supply pressing direction S are partly orthogonal. As a result, it is possible to reliably produce the state in which the power supply pressing direction S is partly orthogonal to the pressing action line Y and the guide direction Z.

Mounting the Process Unit

Referring to FIG. 25, first, the process unit 230 is mounted on the unit frame 211. The mounting is done as follows.

First, the side frame guide roller 232c and rear beam guide roller 234b are mounted onto the slide rail 211c1 by inserting them into the space to the rear of the slide guide roller 211c2 that is positioned on the front most end of the slide guide frame 211c. In this state, the slide guide roller 211c2, the side frame guide roller 232c and the rear beam guide roller 234b are caught between the guide rib 232b of the slide rail 211c1 and the side frame 232.

If the process unit 230 is pressed further behind in this state, the slide guide roller 211c2, the side frame guide roller 232c and the rear beam guide roller 234b will rotate while caught between the slide rail 211c1 and the guide rib 232b. As a result, the process unit 230 will be smoothly guided into the unit frame 211. At this time, the separator boss 241f and the pressing boss 241g1 mounted on the top end of the developer cartridge 240 will pass above the cam support frame upper plate 219b2.

If the process unit 230 is pushed further to the rear, with the side frame guide roller 230 and rear beam guide roller 234b passing the slide rail 211c1 and the front end of the guide rib 232b of the side frame 232 passing the slide guide roller 211c2, the process unit will move slightly downward. In this case, the slide rail 211c1 and the guide rib 232b will be facing each other in close proximity. Moreover, the separator boss 241f and the pressing boss 241g1 will also descend to be housed in the boss housing opening 219b5.

Setting the Position of the Developer Cartridge

Referring to FIG. 25, one of the cylindrical cam parts 219a is moved in the front-rear direction by a drive power source (not shown) mounted on the unit casing 211 with the process unit 230 mounted onto the unit frame 211 in this manner. In this case, one of the pinion gears 219c meshed with the rack gear 219a2 of the cam base 219a1 on the appropriate cylindrical cam part 219a rotates. The rotation of the pinion gear 219c causes the other pinion gear 219c meshed with the pinion gear 219c through the gear axis 219d to rotate as well. The other cylindrical cam part 219a meshed with the other pinion gear 219c also moves. In this way, one pair of cylindrical cam parts 219a moves in sync through one pair of pinion gears 219c and the gear axis 219d. As a result, the position of the developer cartridge 240 is set to either the retired position or pressed position. Referring to FIG. 26 and FIG. 27, the setting of the position of the developer cartridge 240 can be performed by setting the position in the front-rear direction L of the cylindrical cam part 219a.

In short, referring to FIG. 25 and FIG. 26, by setting the position of the cylindrical cam part 219a in the front-rear direction L, the auxiliary cam part 219e positioned to face the boss housing opening 219b5 will be set to either rise or fall. The standing auxiliary cam part 219e protrudes towards the boss housing opening 219b5. As a result, the separator boss 241f is pushed upward. By keeping the auxiliary cam part 219e standing, the separator boss 241f will be held in the raised position. As a result, the developer cartridge 240 will be held in the retired position.

Moreover, referring to FIG. 25 and FIG. 27, setting the position of the cylindrical cam part 219a in the front-rear direction L sets whether the pressing boss 241g1 is depressed/not depressed by the pressing boss depress part 219a8. Depressing of the pressing boss 241g1 by the pressing boss depress part 219a8 causes the developer cartridge 240 to be impelled downward, moving it to the pressed position.

Selective Forcing of Multiple Developer Cartridges

Referring to FIG. 25, the multiple (four) developer cartridges 240 arranged along the front-rear direction L are impelled selectively downward in response to the position of the cylindrical cam part 219a along the front-rear direction L. The selective forcing is performed as follows.

Action of Linear Cam

First, the action of the linear cam mechanism 219 shown in FIG. 25 will be described using FIG. 29 through FIG. 32.

Referring to FIG. 29B and FIG. 30, when the cylindrical cam part 219a is in the rearmost position, the foremost auxiliary cam part 219e′ and the other auxiliary cam part 219e are both in upright position and in contact with the auxiliary cam contact wall 219a6. The separator boss 241f is also placed on the separator boss mount 219e3 (219e3′) of the upright auxiliary cam part 219e (219e′). Moreover, both the foremost pressing boss depress area 219a8′ and the other pressing boss depress area 219a8 are positioned to the rear of the pressing boss 241g1.

When the cylindrical cam part 219a starts to move to the front from the state shown in FIG. 30, the auxiliary cam support 219a5 (219a5′) moves to the front while sliding over the auxiliary cam part 219e (219e′). At this time, seen relatively, the auxiliary cam part 219e (219e′) appears to be moving to the rear over the auxiliary cam support 219a5 (219a5′). Note that the auxiliary cam part 219e (219e′) does not move along the front-rear direction. Therefore there is no change in the relative position in the front-rear direction between the auxiliary cam part 219e (219e′) and the separator boss 241f. Furthermore, the movement of the cylindrical cam part 219a to the front causes the tip of the pressing boss depress area 219a8 (219a8′) to approach the pressing boss 241g1.

First, this causes the foremost auxiliary cam rotation protrusion 219a9′ to collide with the second downward protrusion of the auxiliary cam 219e5′ on the foremost auxiliary cam part 219e′. (At this time, auxiliary cam rotation protrusion 219a9 is not yet in contact with the second downward protrusion of the auxiliary cam 219e5 on the foremost auxiliary cam part 219e.) As a result, the foremost auxiliary cam part 219e′ rotates counterclockwise. It then moves to the down state, and drops from the auxiliary cam support 219a5′ to be housed in the auxiliary cam exposed opening 219a7′ positioned foremost. As a result, the separator boss 241f positioned foremost is relieved of the raising force and the separator boss 241f descends.

Moreover, referring to FIG. 31, only the tip of the foremost pressing boss depress area 219a8′ rides up onto the pressing boss 241g1 positioned foremost. As a result, only the pressing boss 241g1 is selectively depressed downward.

When the cylindrical cam part 219a moves further to the front from the state shown in FIG. 31, the other auxiliary cam rotation protrusion 219a9 and the second downward protrusion of the auxiliary cam 219e5 collide. As a result, the other auxiliary cam part 219e also falls. Moreover, the other pressing boss depress area 219a8 also rides up onto the other pressing boss 241g1. In this way, as shown in FIG. 32, all of the separator bosses 241f descend, and all of the pressing bosses 241g1 are depressed downward.

On the other hand, as shown in FIG. 32, when the cylindrical cam part 219a begins to move to the rear from the foremost position, first the first downward protrusion of the auxiliary cam 219e4 on the three auxiliary cam parts 219e other than the foremost auxiliary cam part 219e′ collide with the tip of the auxiliary cam support 219a5. The three auxiliary cam parts 219e then rotate counterclockwise in the figure. As a result of the rotation, the three auxiliary cam parts 219e enter standing state, as shown in FIG. 31, and the separator boss mount 219e3 at the tip faces the separator boss 241f. Moreover, the auxiliary cam part 219e rides up onto the auxiliary cam support 219a5 in this raised state. As a result, the separator boss 241f is pressed upward. At this time, the foremost auxiliary cam part 219e′ is still lowered. In short, the foremost separator boss 241f has not yet been raised up by the foremost auxiliary cam part 219e′.

At the same time, the pressing boss depress areas 219a8 other than the foremost pressing boss depress area 219a8′ are released from above the pressing boss 241g1. As a result, the pressing boss depress area 219a8 is released from the depressive force of the pressing boss 241g1. At this time, the foremost pressing boss depress area 219a8′ is still riding on top of the foremost pressing boss 241g1. In short, the foremost pressing boss 241g1 is still depressed by the foremost pressing boss depress area 219a8′.

When the cylindrical cam part 219a moves further to the rear from the position shown in FIG. 31, the foremost auxiliary cam part 219e′ stands up. Moreover, the foremost pressing boss depress area 219a8 is also released from above the foremost pressing boss 241g1. In this way, as shown in FIG. 30, all of the separator bosses 241f are held above, and the depressive force on all of the pressing bosses 241g1 is released.

Selective Impelling Action on the Developer Cartridge

As a result of the foregoing action of the cylindrical cam part 219a and the auxiliary cam part 219e, the black developer cartridge 240K positioned foremost, the cyan developer cartridge 240C, etc., are differentially impelled downward.

In short, as shown in FIG. 33, depressive force on all of the pressing bosses 241g1 is released during actions not involving the formation of an image because all of the pressing boss depress areas 219a8 (219a8′) are released from above the pressing boss 241g1. Moreover, during actions not involving the formation of an image, all of the separator bosses 241f will be kept raised because all of the auxiliary cam parts 219e (219e′) stand above the auxiliary cam support 219a5 (219a5′). As a result, the black developer cartridge 240K, cyan developer cartridge 240C, etc., are all retained at the retired position. Consequently, all of the developer rollers 244 and photosensitive drums 252 are held apart during actions not involving the formation of an image.

Moreover, as shown in FIG. 34, during the formation of images using only black, the foremost pressing boss depress area 219a′ rides up onto the pressing boss 241g1, and the foremost auxiliary cam part 219e′ falls over. As a result, the pressing boss 241g1 is depressed onto the foremost black developer cartridge 240K, and the upwards force on the separator boss 241f is released.

In this way, the raising force on the separator boss 241f is released from the black developer cartridge 240K, and the pressing boss 241g1 descends, causing the handle 241g to rotate slightly clockwise in FIG. 34 around the hinge 241h, as described above. As a result of the rotation of the handle 241g, the pressing member 241g2 mounted on the free end moves downward. As a result of the downward movement of the pressing member 241g2, the urging mechanism 241k is activated, impelling the developer cartridge case 241 downward. Then, only the developer roller 244 on the black developer cartridge 240K comes into contact with the photosensitive drum 252.

In this way, when forming an image using only black, the cyan developer cartridge 240C, etc., are retained in the retired position and only the black developer cartridge 240K used to form the image moves to the pressed position.

Furthermore, as shown in FIG. 35, all of the developer cartridge cases 241 are impelled downward when forming a full color image. As a result, the black developer cartridge 240K, cyan developer cartridge 240C, etc., all move to the pressed position.

Action and Effect of Another Illustrative Aspect

In this aspect, the conductive part 247 is pressed by the relay electrode part 258 in the power supply pressing direction S, which is roughly orthogonal to the pressing action line Y, a straight line formed by connecting the contact position CP and pressing position PP. Consequently, the contact between the developer roller 244 (toner bearing surface 244b) at the contact position CP with the photosensitive drum 252 (image bearing surface 252b) is made more stable. Moreover, power supply by the relay electrode part 258 through the conductive part 247 to the developer roller 244 is also conducted more stably. Therefore, this aspect makes it possible to form better images.

Moreover, an electrical connection is formed between the power supply protrusion 247b and the relay electrode part 258 when the power supply counterpart 258c1 formed roughly parallel to the pressing action line Y faces and comes into contact with the power supply protrusion 247b. As a result, it is possible to stably set the normal direction of the power supply counterpart 258c1 at the contact point between the power supply protrusion 247b and the power supply counterpart 258c1, i.e., the power supply pressing position SP (see FIG. 24), to a direction roughly orthogonal to the pressing action line Y. Consequently, it is possible to obtain a relay electrode part 258 and conductive part 247 with a simpler device configuration that permits the power supply pressing direction S to be roughly orthogonal to the pressing action line Y.

Here, the power supply counterpart 258c1 is roughly parallel to the alignment collar housing base 251a2 (guide direction Z). Therefore, when the alignment collar 246 moves along the pressing action line Y in the alignment collar housing base 251a2, the power supply counterpart 258c1 and power supply protrusion 247b move relatively along the pressing action line Y and guide direction Z. As a result, the toner bearing surface 244b on the developer roller 244 and the image bearing surface 252b on the photosensitive drum 252 come into contact in the prescribed state, making it possible to ensure the state of power supply to the developer roller 244 from the relay electrode part 258 from the point in time at which positioning for both is complete. Consequently, this reduces the startup time of the color laser printer 200 when forming an image.

Moreover, the power supply protrusion 247b can extend in a directionorthogonal to the pressing action line Y and power supply pressing direction S. Consequently, it is possible to maintain a stable contact state between the developer roller 244 and the photosensitive drum 252 at the contact position CP, while also improving power supply provision to the developer roller 244 through the conductive part 247 from the relay electrode part 258.

Moreover, from the width direction W, the position where the conductive part 247 and the relay electrode part 258 come in contact (power supply pressing position SP) overlaps with the coupling shield sleeve guide groove 251e1 (coupling housing base 251e2) that houses the coupling 248a (coupling shield sleeve 248a2). Furthermore, the power supply pressing position SP is within the range of the outer diameter of the coupling shield sleeve 248a2.

Consequently, it is possible to stabilize contact between the developer roller 244 and the photosensitive drum 252 at the contact position CP and power supply to the developer roller 244 through the conductive part 247 from the relay electrode part 258, while also stably supplying rotational driving force to the developer cartridge 240.

Moreover, in this aspect, when the alignment collar 246 moves along the pressing action line Y within the color housing base 251a2, the guide surface 241m1 formed roughly parallel to the tip of the guide protrusion 241m, i.e., the pressing action line Y, comes into contact with the developer cartridge insertion guide roller 257, which is supported to rotate freely by the floor wall 251b.

Consequently, when mounting a developer cartridge 240 onto the process unit frame 230a (photosensitive unit frame 251), it is possible to smoothly guide movement of the alignment collar 246 and the power supply protrusion 247b along the pressing action line Y. Therefore, it is possible to smoothly mount the developer cartridge 240 onto the process unit frame 240a, while also providing a good electrical contact between the relay electrode part 258 and the conductive part 247, and a stable contact between toner retaining surface 244b and the photosensitive drum 252 at the contact position CP.

Moreover, the angle formed by the developer cartridge pressing direction X and the pressing action line Y is set to roughly 20 degrees. As a result, the guide surface 241m1 of the guide protrusion 241m is pressed with the prescribed force, neither too strong nor too weak, towards the developer cartridge insertion guide roller 257. Moreover, it is possible to deliver the force from the developer cartridge spring 241k3 to the contact position CP without any major loss.

Consequently, the developer cartridge insertion guide roller 257 rotates smoothly while maintaining contact between the developer cartridge insertion guide roller 257 and the guide surface 241m1. As a result, the movement of the developer cartridge 240 along the guide direction Z will be guided smoothly into the developer cartridge insertion guide roller 257. Consequently, it is possible to stably and accurately maintain the prescribed state of contact between the toner bearing surface 244b on the developer roller 244 and the image bearing surface 252b on the photosensitive drum 252.

Moreover, in this aspect, an alignment collar 246 that covers the developer cartridge rotational drive axis 244a from the outside is used to position the developer cartridge 240. As a result, positioning of the developer cartridge 240 and the process unit frame 230a (photosensitive unit frame 251) will be done in the vicinity of the developer roller rotational drive axis 244a. Consequently, it is possible to ensure a better contact using a simpler device configuration for the contact between the developer roller 244 and the photosensitive drum 252 at the contact position CP.

Moreover, when mounting the developer cartridge 240 onto the process unit frame 230a, the alignment collar 246 of the developer cartridge 240 is housed in the alignment collar guide groove 251a1 on the photosensitive unit frame 251. Following this, the alignment collar 246 reaches the alignment collar housing base 251a2 at the bottom end of the alignment collar guide groove 251a1. At this time, the alignment collar 246 moves along the pressing action line Y within the alignment collar housing base 251a2. When the alignment collar 246 reaches the prescribed position on the alignment collar housing base 251a2, positioning is performed for the developer cartridge 240 and the process unit frame 230a (photosensitive unit frame 251).

According to the above aspect, when mounting the developer cartridge 240 onto the process unit frame 230a, it is possible to perform positioning of both more smoothly and accurately. Consequently, according to this configuration, it is possible to regularly obtain a better electrical connection between the relay electrode part 258 and the conductive part 247, and regularly obtain accurate positioning of the developer roller 244 and the photosensitive drum 252.

Moreover, the conductive part 247 supports the developer roller rotational drive axis 244a and the supply roller rotational drive axis 243a in such a way as to enable rotation, while electrically connecting the developer roller rotational drive axis 244a and the supply roller rotational drive axis 243a. As a result, power supply to the supply roller 243 and the developer roller 244 is performed via the relay electrode part 258 and the conductive part 247 such that the supply roller 243 and the developer roller 244 will reach roughly the same voltage. Consequently, it is possible to form a prescribed contact between the toner bearing surface 244 on the developer roller 244 and the photosensitive drum at the contact position CP, while also stably supplying power to the supply roller 243 and developer roller 244 such that the supply roller 243 and developer roller 244 reach roughly the same voltage.

Moreover, in this aspect, an alignment collar 246 having a round outer shape seen from the width direction W protrudes from one end of the developer cartridge case 241 in the width direction W, and a coupling 248a (coupling shield sleeve 248a2) having a larger diameter protrudes on the other side. In addition, the coupling shield sleeve guide groove 251e1 is wider than the alignment collar guide groove 251a1 to an extent that allows it to house the coupling 248a.

Consequently, if an attempt is made to insert the alignment collar 246 into the coupling shield sleeve guide groove 251e1, or to insert the coupling 248a (coupling shield sleeve 248a2) into the alignment collar guide groove 251a1, the difference in external diameter will prevent the insertion. Concretely, it is not possible to insert a coupling 248a (coupling shield sleeve 248a2) with a large diameter into an alignment collar guide groove 251a1 with a width adapted to an alignment collar 246 with a small diameter.

Consequently, according to this configuration, it is possible to effectively prevent mis-mounting of the developer cartridge 240 onto the process unit frame 230a (photosensitive unit frame 251).

Moreover, according to this configuration, it is possible to reduce the length of the drive rotation unit 281 by an extent equal to the size of the protrusion of the coupling 248a (coupling shield sleeve 248a2). Consequently, it is possible to reduce the size in the width direction W of the rotational drive force delivery mechanism 280 mounted on the unit frame 211. This makes it possible to further reduce the size of the color laser printer 200.

Moreover, impelling force is applied towards the photosensitive drum 252 on the developer cartridge 240 by the handle 241g and urging mechanism 241k mounted on the top end of the developer cartridge case 241, i.e., the ceiling plate 241c. Consequently, it is possible use a fairly simple device configuration to form the prescribed impelling force towards the contact position CP on the developer roller 244.

Moreover, in this aspect, by moving the cylindrical cam part 219a mounted on the linear cam mechanism 219 along the front-rear direction L in which the multiple developer cartridges 240 are arranged, the multiple pressing bosses 241g1 and pressing members 241g2 will selectively move toward the developer cartridge spring 241k3. As a result, only those of the multiple developer cartridges 240 used to form images will be impelled toward the contact position CP. Consequently, it is possible to effectively inhibit deterioration of the developer roller 244, etc., due to long-term continuous friction between the developer roller 244 and the photosensitive drum 252 using a fairly simple device configuration.

Other Suggested Formations

Moreover, as stated previously, the foregoing aspects are merely representative, and the present invention is not restricted to the foregoing aspects, but may be modified in various ways so long as the fundamental aspects of the present invention are not modified.

Below are a few examples of other possible formations, though the invention is not so limited
(i) The image formation devices that are the subject of the present invention are not restricted to electro photo types. Moreover, if the subject of the present invention happens to be an electro photo type image formation device, the image formation device is not restricted to laser printers.
(ii) The configurations of the aspects described herein may be exchanged or combined.
(iii) Moreover, the photosensitive unit frame 251 may be omitted from some of the above aspects, with the photosensitive drum 252 supported directly by the process unit frame 230a and the developer cartridge 240 directly mounted and removed.
(iv) Moreover, aspects may be configured in such a way that the photosensitive unit 250 can be freely mounted and removed from the process unit frame 230a.
(v) Aspects of the invention may be configured in such a way that the process unit frame 230a can be pulled out from the front of the unit frame 211 but cannot be easily mounted and removed from the unit frame 211.
(vi) The angle formed by the developer cartridge pressing direction X and the pressing action line Y in some aspects is not restricted to 20 degrees. It is preferable that the angle formed by both be no greater than 25 degrees in order that the guide surface 241m1 of the guide protrusion 241m be pushed without excessive force towards the developer cartridge insertion guide roller 257. On the other hand, it is preferable that the angle formed by both be no less than 5 degrees in order that the guide surface 241m1 of the guide protrusion 241m be pushed with sufficient force towards the developer cartridge insertion guide roller 257.
(vii) Certain aspects may be configured in such a way that one of the cylindrical cam parts 219a can move in sync by having a drive mechanism not shown drive the rotation of at least one of the pair of pinion gears 219c or the gear axis 219d.

1. An image formation device comprising:
a developer cartridge that includes a developer carrier configured to carry a developer, a developer cartridge case configured to house the developer carrier, and a conductive member mounted on the developer cartridge case and electrically connected to said developer carrier;
a developer cartridge mounting frame including an image carrier configured to form an image on a recording medium using the developer carried on the developer carrier by contacting the developer carrier at a designated contact position, wherein the developer cartridge is configured to be installed in and removed from the developer cartridge mounting frame;
an urging member configured to urge in a pressing direction a portion of the developer cartridge case at a designated pressing position, and wherein in response to the urging member urging the portion of the developer cartridge case, the developer carrier is pressed against the image formation carrier at the contact position; and
a power supply member configured to allow the conductive member to receive power when contacting the power supply member in a direction perpendicular to a line that connects the contacting position and the pressing position.

2. An image forming device according to claim 1, wherein:
an angle formed by the pressing direction and the line that connects the contacting position and the pressing position is greater than or equal to 0 degrees and less than or equal to 25 degrees.

3. An image forming device according to claim 1, wherein:
the conductive member includes a protrusion configured to be pressed by the power supply member;
the power supply member includes a portion configured to face the protrusion; and
the portion of the power supply member is configured to be parallel to the line that connects the contacting position and the pressing position.

4. An image forming device according to claim 1, wherein:
the developer cartridge includes an alignment projection configured to cause the developer cartridge to be aligned with the developer cartridge mounting frame by being guided by a guide formed on the developer cartridge mounting frame; and
the guide including an edge portion adjacent to the image carrier, the edge portion configured to allow the alignment projection to move along the line that connects the contacting position and the pressing position.

5. An image forming device according to claim 4, wherein:
the developer carrier includes a driving shaft having a center axis perpendicular to the line that connects the contacting position and the pressing position; and
the alignment projection includes the driving shaft of the developer carrier.

6. An image forming device according to claim 5, wherein:
the developer cartridge includes a developer supply member configured to supply developer to the developer carrier;
the developer supply member includes a driving shaft; and
the conductive member is configured to electrically connect the driving shaft of the developer supply member and the driving shaft of the developer carrier.

7. An image forming device according to claim 4, wherein:
the developer cartridge mounting frame includes a first wall that the guide is formed on, and a second wall;
the developer cartridge case includes a guiding projection configured to contact the second wall at a contacting portion when the developer cartridge is installed in the developer cartridge mounting frame; and
a surface of the contacting portion contacting the second wall is parallel to the line that connects the contacting position and the pressing position.

8. An image forming device according to claim 7, wherein:
a roller configured to roll while being in contact with the contacting portion when the alignment projection moves along the edge portion.

9. An image forming device according to claim 4, further including:
a drive unit configured to apply a driving force to drive the developer carrier; and
a frame configured to support the developer cartridge mounting frame, wherein the developer cartridge includes a driving force input portion configured to receive the driving force from the drive unit;
the conductive member is arranged on a first end of the developer cartridge case perpendicular to the line that connects the contacting position and the pressing position;
the driving force input portion is arranged to project from a second end of the developer cartridge case, the second end being different from the first end; and
a position at which the conductive member and the power supply member come into contact with each other overlaps the driving force input portion.

10. An image forming device according to claim 9, wherein:
the alignment projection is formed to project from the first end of the developer cartridge case, wherein the alignment projection is formed to have a first circumference;
the driving input portion having a second circumference different from the first circumference of the alignment projection; and
a driving force input opening is formed on the developer cartridge mounting frame, the driving force input opening receiving the driving force input portion, and the driving force input opening having a different width from the guide.

11. An image forming device according to claim 3, wherein:
the protrusion of the conductive member extends in a direction orthogonal to the line that connects the contacting position and the pressing position and the direction, the direction being perpendicular to the line that connects the contacting position and the pressing position.

12. An image forming device according to claim 1 further comprising:
a pressing member configured to press the urging member toward the developer cartridge case;
a handle pivotably attached to the developer cartridge case; and
an urging member support provided on an upper edge of the developer cartridge case and configured to support the urging member;
wherein the pressing member is provided at an edge away from a pivoting edge of the handle and is configured to press the urging member.

13. An image forming device according to claim 12, wherein:
the developer cartridge mounting frame is configured to allow a plurality of the developer cartridges to be simultaneously installed while each developer cartridge is aligned in parallel with each other developing cartridge, and
the pressing member includes a plurality of pressing members corresponding to each developer cartridge.

14. An image forming device according to claim 13, further comprising:
a force applying member configured to apply a force to the plurality of pressing members.

15. An image forming device according to claim 14, wherein:
the force applying member includes a translation cam member configured to move along a front-rear direction.

16. A process cartridge configured to be installed in and removed from a frame of an image forming device, the process cartridge comprising:
a developer cartridge that includes a developer carrier configured to carry a developer, a developer cartridge case configured to house the developer carrier and the developer, and a conductive member provided on the developer cartridge case, the conductive member being electrically connected to the developer carrier, the developer cartridge case including a portion urged in a pressing direction by an urging element at a designated pressing position; and
a process cartridge frame that holds an image carrier to which the developer is carried by contacting the developer carrier at a designated contact position, the developer cartridge being configured to be installed in and removed from the process cartridge frame;
wherein the conductive member is configured to be pressed by a power supply member in a direction perpendicular to a line that connects the pressing position and the contacting position.

17. A process cartridge according to claim 16, wherein:
an angle formed by the pressing direction and the line that connects the contacting position and the pressing position is greater than or equal to 0 degrees and less that or equal to 25 degrees.

18. A process cartridge according to claim 16, wherein:
the developer cartridge includes an alignment projection configured to cause the developer cartridge to be aligned with the process cartridge frame by being guided by a guide formed on the developer cartridge mounting frame; and
the guide including an edge portion adjacent to the image carrier, the edge portion configured to allow the alignment projection to move along the line that connects the contacting position and the pressing position.

19. A process cartridge according to claim 18, wherein:
the developer carrier includes a driving shaft having a center axis perpendicular to the line that connects the contacting position and the pressing position; and
the alignment projection includes the driving shaft of the developer carrier.

20. A process cartridge according to claim 19, wherein:
the developer cartridge includes a developer supply member configured to supply developer to the developer carrier;
the developer supply member includes a driving shaft; and
the conductive member is configured to electrically connect the driving shaft of the developer supply member and the driving shaft of the developer carrier.

21. A process cartridge according to claim 18, wherein:
the process cartridge frame includes a first wall that the guide is formed on, and a second wall;
the developer cartridge case includes a guiding projection configured to contact the second wall at a contacting portion when the developer cartridge is installed in the process cartridge frame; and
a surface of the contacting portion contacting the second wall is parallel to the line that connects the contacting position and the pressing position.

22. A process cartridge according to claim 21, wherein:
a roller configured to roll while being in contact with the contacting portion when the alignment projection moves along the edge portion.

23. A process cartridge according to claim 18, wherein:
the power supply member configured to allow the conductive member to receive power when contacting the power supply member and to include a portion configured to face the protrusion; and
the portion of the power supply member is configured to be parallel to the line that connects the contacting position and the pressing position.

24. A process cartridge according to claim 23, wherein:
the developer cartridge includes a driving force input portion configured to receive a driving force from a drive unit on the frame;
the conductive member is provided on a first end of the developer cartridge case perpendicular to the line that connects the contacting position and the pressing position;
the driving force input portion is provided to project from a second end of the developer cartridge case, the second end being different from the first end; and
a position, where the conductive member and the power supply member come in contact with each other, overlaps the driving force input portion.

25. A process cartridge according to claim 24, wherein:
the alignment projection is formed to project from the first end of the developer cartridge case, wherein the alignment projection is formed to have a first circumference;
the driving input portion having a second circumference different from the first circumference of the alignment projection; and
a driving force input opening is formed on the developer cartridge mounting frame, the driving force input opening receiving the driving force input portion, and the driving force input opening having a different width from the guide.

26. A process cartridge according to claim 23, wherein:
the protrusion of the conductive member extends in a direction orthogonal to the line that connects the contacting position and the pressing position and the direction, the direction being perpendicular to the line that connects the contacting position and the pressing position.

27. A process cartridge according to claim 16, wherein:
the urging member is configured to urge in the pressing direction the portion of the developer cartridge case at the designated pressing position, and wherein in response to the urging member urging the portion of the developer cartridge case, the developer carrier is pressed against the image formation carrier at the contact position; and
a pressing member configured to press the urging member toward the developer cartridge case;
a handle pivotably attached to the developer cartridge case; and
an urging member support provided on an upper edge of the developer cartridge case and configured to support the urging member;
wherein the pressing member is provided at an edge away from a pivoting edge of the handle and is configured to press the urging member.

28. A process cartridge according to claim 27, wherein:
the process cartridge frame is configured to allow a plurality of the developer cartridges to be simultaneously installed while each developer cartridge is aligned in parallel with each other developing cartridge, and
the pressing member includes a plurality of pressing members corresponding to each developer cartridge.

29. A process cartridge according to claim 28 characterized by being further comprised of:
a force applying member configured to apply a force to the plurality of pressing members.

30. A process cartridge according to claim 29, wherein:
the force applying member includes a translation cam member configured to move along a front-rear direction.

31. A developer cartridge for use in an image forming device including an image carrier configured to be supported in a developer cartridge mounting frame, which is configured to be supported inside the image forming device, the developer cartridge being configured to be installed in and removed from the developer cartridge mounting frame, the developer cartridge comprising:
a developer carrier configured to carry the developer;
a developer cartridge case configured to house the developer carrier;
a conductive member mounted on the developer cartridge case and electrically connected to the developer carrier;
wherein the developer cartridge case is configured to allow the developer carrier to be pressed, at a designated pressing position, against the image carrier; and
the conductive member is configured to be supplied with power while being pressed by a power supply member in a direction perpendicular to a line that connects a contacting position where the developer carrier and the image carrier contact each other, and the designated pressing position.

32. A developer cartridge according to claim 31, wherein:
an angle formed by the pressing direction and the line that connects the contacting position and the pressing position is greater than or equal to 0 degrees and less that or equal to 25 degrees.

33. A developer cartridge according to claim 31, wherein:
the conductive member includes a protrusion.

34. A developer cartridge according to claim 31 further comprising:
an alignment projection configured to cause the developer cartridge to be aligned with the developer cartridge mounting frame by being guided by a guide formed on the developer cartridge mounting frame, the guide including an edge portion adjacent to the image carrier, the edge portion configured to allow the alignment projection to move along the line that connects the contacting position and the pressing position;
the developer carrier includes a driving shaft having a center axis; and
the alignment projection includes the driving shaft of the developer carrier.

35. A developer cartridge according to claim 34 further comprising:
a developer supply member configured to supply developer to the developer carrier, the developer supply member including a driving shaft;
wherein the conductive member is configured to connect the driving shaft of the developer supply member and the driving shaft of the developer carrier.

36. A developer cartridge according to claim 34, wherein:
the developer cartridge mounting frame includes a first wall that the guide is formed on, and a second wall;
the developer cartridge case includes a guiding projection configured to contact the second wall at a contacting portion when the developer cartridge is installed in the developer cartridge mounting frame; and
a surface of the contacting portion contacting the second wall is parallel to the line that connects the contacting position and the pressing position.

37. A developer cartridge according to claim 36, wherein:
wherein the contacting portion of the guiding projection is configured to contact a roller of the developer cartridge mounting frame when the alignment projection moves along the edge portion.

38. A developer cartridge according to claim 34, further comprising:
a driving force input portion configured to receive a driving force to drive the developer carrier, from a driving unit in the image forming device, wherein
the conductive member is provided on a first end of the developer cartridge case,
the driving force input portion is provided to project from a second end of the developer cartridge case, the second end being different from the first end, and
a position at which power is supplied to the conductive member overlaps the driving force input portion.

39. A developer cartridge according to claim 38, wherein:
the alignment projection is formed to project from the first end of the developer cartridge case, wherein the alignment projection is formed to have a first circumference;
the driving input portion having a second circumference different from the first circumference of the alignment projection.

40. A developer cartridge according to claim 33, wherein:
the protrusion of the conductive member extends in a direction orthogonal to the line that connects the contacting position and the pressing position and the direction, the direction being perpendicular to the line that connects the contacting position and the pressing position.

41. A developer cartridge according to claim 31, further comprising:
an urging member is configured to urge in the pressing direction the portion of the developer cartridge case at the designated pressing position, and wherein in response to the urging member urging the portion of the developer cartridge case, the developer carrier is pressed against the image formation carrier at the contact position;
a pressing member configured to press the urging member toward the developer cartridge case;
a handle pivotably attached to the developer cartridge case; and
an urging member support provided on an upper edge of the developer cartridge case and configured to support the urging member;
wherein the pressing member is provided at an edge away from a pivoting edge of the handle and is configured to press the urging member.
